(19) United States
(12) Patent Application Publication
(10) Pub. No.: US 2010/0250400 A1
(43) Pub. Date: Sep. 30, 2010

(54) APPARATUS AND METHODS FOR THE SALE OF SOFTWARE PRODUCTS

(75) Inventor: Alvaro Fernández Gutiérrez, Barcelona (ES)

Correspondence Address: BERENBAUM WEINSHIENK PC, 370 17TH STREET, SUITE 4800, DENVER, CO, 80202, US

(73) Assignee: Media Patents, S.L., Barcelona (ES)

(21) Appl. No.: 12/749,158

(22) Filed: Mar. 29, 2010

Related U.S. Application Data
(63) Continuation-in-part of application No. 11/797,633, filed on May 4, 2007.

(30) Foreign Application Priority Data
Nov. 10, 2006 (ES) 200602849

(51) Int. Cl. G06Q 30/00; G06F 21/00

(52) U.S. Cl. 705/27; 726/29

(57) ABSTRACT

Establishing a first communication between a programmable electronic device and a first site for an online purchase of a software product followed by establishing a second communication between the programmable electronic device and a second site for the purpose of enabling a use of the software product in the programmable electronic device. In one implementation, the software product is transmitted to the programmable electronic device during the first communication, while in another implementation the software product is transmitted to the programmable electronic device after the use enabling process made during the second communication is complete. In one implementation, the use enabling process involves the activation of a use license associated with the software product.

### CROSS-REFERENCE TO RELATED APPLICATIONS

This application is a continuation-in-part of U.S. patent application Ser. No. 11/797,633, filed May 4, 2007, which relates to and claims priority to Spanish Application No. 200602849 filed Nov. 10, 2006.

### TECHNICAL FIELD

The invention relates to the field of on-line sales of software products through a data network, for example, the Internet.

### BACKGROUND

Software manufacturing companies currently sell their software products both by direct sales from their own websites and by indirect sales through their distributors.

In the case of direct sales, the purchaser usually downloads a software product from the software company's website and pays for and obtains a use license on-line on said website. Another commonly used option consists of the purchaser ordering the software product on-line on the company's website and the latter sending the software product by mail in the form of a CD or a DVD packed in a box containing a serial number for obtaining a use license.

Indirect sales through distributors allow a software company to multiply its sales channels and drastically reduce or even eliminate its own sales structure. Currently, when the sale is carried out indirectly through a shop or distributor, the software product is distributed in the form of a physical carrier, such as a CD or a DVD, packed in a box containing a serial number for activating a use license. This distribution in the form of a physical product is not very efficient compared to the on-line downloading of the software product from a website because it uses human and energy resources and raw materials.

Other on-line sales systems are known in which a software company advertises its software products on several independent websites which are not connected to it. The purchaser visits one of those websites, selects one of the advertised software products and is then automatically redirected to the software manufacturing company's website where the purchaser can acquire the software product on-line, like in the case of a direct sale set forth previously. In compensation, the software manufacturing company pays the owner of the independent website a commission for each forwarding to its own website. These sales systems are not indirect sales systems through distributors, rather they are similar to the case of a direct sale set forth previously, with the only difference that they allow advertising the products with a greater reach through independent websites. The software manufacturing company continues to support on its own website the necessary structure for carrying out the whole sales process, including the structure allowing downloading the software product, the payment for and the granting of a use license.

### SUMMARY

According to an aspect of the some embodiments, a process, including an apparatus and computer readable medium thereof, of on-line sale of software product use licenses through a data network, are provided by: offering online each of said software products to be downloaded online, by a plurality of vendor sites; offering for purchase online a use license for one of said software products offered by one of said vendor sites and downloaded on-line; and authorizing activation of said use license on-line by a licensing site different from said vendor sites.

Various embodiments also comprise a software component which allows carrying out said process, including the apparatus and the computer readable medium thereof

In the sense of this description and of the attached claims, a software product refers to a product formed by a set of instructions which can be loaded in the memory of a programmable electronic device (e.g., a computer, mobile phone, etc.) and can be executed individually or in combination with another software product. According to this definition, a computer program, an installation program installing a program in the programmable electronic device, a package for updating a computer program, an installing file downloading a computer program or an updating thereof on-line, a computer program library, etc. are examples of software products. The term “programmable electronic device” or simply “device” is used to refer to the different equipment usable in the various implementations disclosed herein. As previously discussed, examples of such devices can be any type of programmable electronic device such as a personal computer, a PDA (Personal Digital Assistant), a mobile phone, a device consisting of a mobile phone and PDA, a Smartphone, a set-top-box, a digital television, a server computer, a client and/or server computer, etc.

A “licensing site” as used herein may be any site which facilitates the exchange of data that is used to enable a download of a software product to an electronic programmable device and/or to enable the use of a downloaded software product in a a programmable electronic device. The data may be used to activate a use license, a key, or any other use enabling modality in which the use of a software product, or a portion thereof, is enabled to be downloaded, or installed, or to run in a device. As such, it is to be appreciated that the terms “licensing site” and “license” used throughout this disclosure encompass licenses and other use enabling modalities in which the use of a software product, or a portion thereof, is enabled to be downloaded, or installed, or to run in a device.

A site refers to any programmable electronic device installation associated with a data network service providing a virtual site connected to the data network and able to exchange information and services on-line with other sites through said data network. According to an aspect of an embodiment, when the data network is the Internet, the vendor sites and licensing sites can be websites comprising a main webpage identified by a URL address.

A software component is understood to refer to a set of instructions which can be loaded in the memory of a programmable electronic device and incorporated in or otherwise associated with a software product to be executed together with the latter, or individually, to and provide specific functions. According to this definition, a dynamic library, a class or set of classes, a control or class with a graphic interface, a set of functions or any other type of software module are examples of software components.

New methods for the on-line sale of software products through a data network in the form of methods, apparatus and computer readable mediums thereof, for the on-line sale of use licenses, or other use enabling modalities, for the software products are disclosed herein.

In accordance with various implementations, methods are provided that combine the advantages of indirect sales through distributors (multiplication of sales channels and reduction or elimination of its own sales structure) with the advantages of direct sales (the possibility of delivering the software product on-line, without a physical carrier).

In accordance with some implementations, a sale is based on separating, on different sites (for example different websites), the process for acquiring the software product, understood as the process by which the purchaser carries out a commercial transaction for acquiring a use license for said software product, from the process for activating said use license, or other use enabling modality, for the software product, according to which the purchaser obtains the serial number, keys or any other type of data or program allowing the purchaser to use the software product in a certain programmable electronic device or devices.

According to various implementations, a software product is offered by a plurality of vendor sites for its on-line acquisition from an acquisition site, and the process for activating a use license, or other use enabling modality, for the software is carried out in a licensing site different from said vendor sites. According to this method, the on-line acquisition of the software product includes an on-line download of said software product as well as the on-line purchase of, for example, a use license on the vendor site which offered the software product. The software product can be downloaded directly from the vendor site itself offering said software product or from a downloading site associated to said vendor site. The use license is purchased on said vendor site, at the time of the download of the software product or afterwards, when it is necessary to obtain a use license, or other use enabling modality, for said software product. Once the use license or other use enabling modality has been paid for, an on-line communication is set up with the licensing/enabling site in order to activate it or otherwise enable the use of the software product in the device. Thus, in accordance with various implementations, a use license which is purchased on said vendor site is an inactive use license, which remains inactive until the activation thereof by said licensing site. In other words, the purchased use license does not authorize use of the software product until the activation of said use license by the licensing site.

When the data network is the Internet, the licensing site is normally the website of a software manufacturing company and the vendor sites are websites of distribution companies which can be independent of the manufacturing company. For the software manufacturing company this advantageously multiplies the range for spreading its software products and at the same time it is released from the obligation of having to manage the downloading and the payment for its software product.

In accordance with various implementations disclosed herein, the purchaser can purchase the use license on-line on a vendor site at the same time the purchaser downloads the software product and, subsequently or simultaneously, carry out the process for activating the use license by communicating with the licensing site. In accordance with some implementations the purchaser can download a demonstration version of the software product from the vendor site that can only be used during a trial period after which it is necessary to obtain a use license. In this case, the use license may be purchased from the vendor site on-line after downloading the software product, at the time in which the purchaser decides to purchase the use license, and then the purchaser can carry out the process for activating the license by communicating with the licensing site.

In some implementations, after the distribution companies have collected payment made by the purchaser, they pay an agreed amount to the manufacturing company for the sale of the use license for the software product.

In accordance with some implementations, an especially advantageous configuration is provided in which a supervising entity is created which, through a supervising site which can set up on-line communications with the acquisition site, the vendor site and the licensing site, ensures that the sales process is carried out in suitable conditions. A manufacturing company and a distribution company can thus register in the supervising entity an agreement according to which the former authorizes the latter to offer its software product under certain conditions. The manufacturing company can withdraw its authorization in the event of non-compliance with the agreement. The supervising entity can also register and authorize the user purchasers of the system. Likewise, the supervising entity can intervene in the different sales processes to ensure that they are carried out in suitable conditions; for example, it can verify that the distribution company is authorized by the manufacturing company to sell the product, that the distribution company pays the manufacturing company the part specified in the agreement for the sale of software products, that the purchaser is a registered and authorized user, that the manufacturing company really has the power to grant use licenses for the software product, etc.).

Certain technical problems exists in the on-line sale of use licenses, or other use enabling modalities, for software products. In the first place, after having downloaded the software product on-line from the vendor site offering it or from a downloading site associated to the latter, it is important that said vendor site can be identified in a reliable manner. Furthermore, this identification information of the vendor site should be available at the time the end user decides to purchase the use license, or other use enabling modality, for the software product the purchaser has downloaded, a time which may not coincide with the download of the software product, but with the installation of the latter in equipment or with the expiration date of a demonstration version of the software product or with the expiration date of the temporary use license purchased previously. Furthermore, the possibility of identifying the vendor site before the activation of the use license is important because the licensing site has to be able to collect from said vendor site the part of the sale corresponding to it, but it must also have the certainty that the identified vendor site is really the one who has carried out the sale and is an authorized site. It is also necessary to be able to assure the purchaser that the purchaser will be able to activate the use license on the licensing site after purchasing it on a vendor site.

Secondly, the method preferably involves a standard implementation that can be generalized for all types of software products. It should prevent that a licensing site which wants to sell its software products through this method has to adapt a software product for each vendor site.

In accordance with various implementations, processes are provided which allow providing the licensing site, in a safe and effective manner, with the identifying data of the vendor site which has offered the software product for its on-line download and in which a use license has been purchased, such that the identifying data of the vendor site can be provided at the time in which the end user needs to activate the use license for the software product, and all of the above such that a licensing site can distribute its software product according to this method of sale without needing to adapt the software product for each vendor site.

In accordance with one implementation, an on-line sale method is provided that comprises incorporating a software component to each of said software products offered by a vendor site, said software component executable together with said software product and managing the activation of a use license for said software product; associating a transmission of identifying data of the vendor site offering said software product to each of said on-line downloading-process of one of said software products; wherein said software component, when executed together with said software product in an equipment, is able to locally access said identifying data of the vendor site and to access identifying data of the licensing site, and launches a process for activating said use license for the software product comprising setting up an on-line communication with said licensing site during which said software component obtains from said licensing site activation data necessary for activating said use license.

Some technical problems set forth are solved due to the fact that the identifying data of the vendor site are transferred during the software product downloading process, and to the fact that the software product incorporates said software component, which does not need to be customized for each vendor site, and is able to locally retrieve, in the equipment where the software product is being executed, the identifying data of the vendor site and of the licensing site. This solution further allows preserving the own or existing copy protection system of existing software products, given that the component can be incorporated in the software product and executed without interfering with said protection system. Nevertheless, as will be seen below in the description of several embodiments of the invention, the process for activating the use license applied by the component is by itself a copy protection system.

When the data network in which the method of sale according to some implementations is the Internet, the identifying data of the vendor site which are transmitted during the downloading process may comprise the location of said vendor site in the network in the form of its URL address.

In a process according to the invention, setting up a communication between two sites must be understood as including either a direct communication between the two sites or an indirect communication through an intermediate site. Thus, for example, the communications set up by the software component with the vendor site or with the licensing site, from the equipment in which the software product is installed, can be carried out through an intermediate site without this affecting the principle of the invention. Indeed, what is important is that the software component locally accesses identifying data of the vendor site and of the licensing site, and from this data it is able to locate these sites in the network on one hand and on the other hand to provide the licensing site with data referring to the vendor site through which the download has been carried out and in which a use license has been purchased. The software component preferably communicates directly with the vendor site and directly with the licensing site. However, it can be provided that in the process for activating the license, the software component communicates directly with the vendor site, it provides it with the identifying data of the licensing site and then the communication with the licensing site is carried out directly through the vendor site. In this case, the process for activating the license would be carried out in the vendor site, but it is really the licensing site which is providing on-line the necessary data for activating the license through the vendor site. On the contrary, it can be provided that the software component communicates directly with the licensing site and that the communication with the vendor site to make the purchase is carried out through the licensing site. As will be seen below, it can also be provided that a supervising site intervenes as an intermediary in the different on-line communications.

In accordance with various implementations, the identifying data of the licensing site can be incorporated in the software product or in the software component. This last solution offers the advantage that the software manufacturing company can have a licensing site different from its main site, therefore the management of the former is facilitated. To that end, the software product may incorporate therein identifying data that includes the URL address of the main webpage of said company, whereas the software component incorporates therein the identifying data of the licensing site. Another advantage is that a single software component serves to integrate the identifying data of the licensing site in all the software products.

In accordance with various implementations, after obtaining said activation data from the licensing site, the software component activates a use license for said software product. Therefore, the entire process for activating the license, leading to the release of the software product so that it can be used, in some embodiments is advantageously done by the software component itself

The on-line purchase on a vendor site of a use license for the software product preferably comprises a transmission of a purchase receipt from said vendor site, and when said software component is executed in said equipment, it locally accesses said purchase receipt and transmits it to the licensing site during the on-line communication during which the software component obtains said activation data from said licensing site. A guarantee that the purchase has been made on one of the authorized vendor sites is thus offered to the licensing site in a particularly efficient and robust manner. The purchase receipt typically and advantageously includes identifying data of the vendor site. Said on-line purchase also preferably comprises setting up an on-line communication between said vendor site and said licensing site, during which said vendor site transmits a purchase receipt to said licensing site. In this way, the licensing site knows that the use license has been purchased and can claim payment of its corresponding part, without needing to wait until the purchaser had installed the software product in an equipment.

In one embodiment of the process according to the invention, an acquisition site sets up an on-line communication with one of said vendor sites, during which said on-line software product downloading process as well as the on-line purchase of the use license for the software product are carried out. This embodiment generally corresponds to the case in which a purchaser downloads a final commercial version of the software product, e.g. a version with no demonstration period, instead of a demonstration version and then the use license must be purchased together with the download. The purchaser obtains the activation of the use license when the software product is installed, when the software component communicates with the licensing site during the process for activating the license.

In another embodiment, which is generally applied to the case in which a purchaser downloads a demonstration version of the software product, when the software component is executed in said equipment, it locally accesses the identifying data of the vendor site and sets up an on-line communication with said vendor site, during which said software component operates the on-line purchase of the use license of said software product. Therefore, the software component only launches the process for the on-line purchase of a use license when the user so decides, for example, by responding to an invitation of the software component itself when the test period of the demonstration version has concluded. Preferably, when the software component is executed in said equipment, it sets up an on-line communication with said licensing site, during which it communicates said identifying data of the vendor site to said licensing site so that said licensing site authorizes the on-line purchase of the software product use license on said vendor site, therefore the purchaser has the certainty that the sale is authorized by the licensing site and therefore the purchaser will be able to subsequently activate the use license.

Several solutions according to the invention can be provided for transmitting the identifying data of the vendor site. In a first solution, said identifying data are introduced in a downloadable file which is downloaded by the acquisition site together with the software product during the downloading process in the on-line communication set up by the acquisition site with the vendor site. In a preferred second solution, the software product is contained in a single downloadable file which is downloaded by the acquisition site during the downloading process, in the on-line communication set up by the acquisition site with the vendor site, and the transmission of identifying data of the vendor site is carried out by introducing said identifying data as file properties metadata of said downloadable file. Introducing said identifying data of the vendor site as file properties metadata of said downloadable file can be done in each of the vendor sites before the software product downloading process, but it is preferably done at the time in which the acquisition site downloads said downloadable file during the downloading process. Another solution includes the transmission of identifying data of the vendor site by transmitting a code to a user operating the software product downloading process, said code being subsequently provided to the software component when it is executed in said equipment. This code can be provided, for example, by means of an on-screen display or by sending it by e-mail.

In an advantageous embodiment, the intervention of a single supervising site, different from the licensing sites and from the vendor sites, is provided. Said single supervising site intervenes as an intermediary in the different communications between the sites participating in the on-line sale, for the purpose of ensuring that said sale is carried out in suitable conditions. The software product downloading process from a vendor site can thus comprise setting up an on-line communication with said supervising site. Likewise, the process for the on-line purchase or the process for activating the license, launched by the software component when it is executed in said equipment, can comprise setting up an on-line communication with said supervising site. The process according to the invention can also comprise setting up an on-line communication between the vendor site and said supervising site, as well as setting up an on-line communication between the licensing site and said supervising site.

In accordance with other implementations, methods are provided that comprise purchasing by use of a first programmable electronic device a software product from a first site and receiving in the first programmable electronic device the software product and purchase receipt data from the first site, the software product comprising a software program; transmitting from the first programmable electronic device at least a portion of the software product and the purchase receipt data to a second programmable electronic device; initiating, by use of first executable instructions associated with the software product, communication between the second programmable electronic device and a second site different from the first site and transferring from the second programmable electronic device at least a portion of the purchase receipt data to the second site; and receiving in the second programmable electronic device from the second site use enabling data associated with the software product that enables the software program to be run on the second programmable electronic device.

In accordance with other implementations, methods are provided that comprise purchasing by use of a first programmable electronic device a software product from a first site and receiving in the first programmable electronic device from the first site purchase receipt data and identification data of the first site, the software product comprising a software program; transmitting from the first programmable electronic device at least a portion of the purchase receipt data and the identification data to a second programmable electronic device; establishing by use of the identification data a communication between the first site and the second programmable electronic device and transmitting from the first site to the second programmable electronic device the software product; initiating communication between the second programmable electronic device and a second site different from the first site and transferring from the second programmable electronic device at least a portion of the purchase receipt data to the second site; and receiving in the second programmable electronic device from the second site use enabling data associated with the software product that enables the software program to be run on the second programmable electronic device. In one implementation, communication between the second programmable electronic device and the second site is accomplished at least in part by use of executable instructions associated with the software product. In yet another implementation, receiving in the second programmable electronic device from the second site use enabling data associated with the software product that enables the software program to be run on the second programmable electronic device occurs prior to transmitting from the first site to the second programmable electronic device the software product.

In accordance with other implementations, methods are provided that comprise purchasing by use of a first programmable electronic device a software product from a first site and receiving in the first programmable electronic device from the first site purchase receipt data and identification data of the first site, the software product comprising a software program; transmitting from the first programmable electronic device at least a portion of the purchase receipt data and the identification data to a second programmable electronic device; establishing by use of the receipt data and/or identification data a communication between the second programmable electronic device and a second site different from the first site; transmitting from the second site to the second programmable electronic device the software product; initiating, by use of executable instructions associated with the software product, communication between the second programmable electronic device and a third site and transferring from the second programmable electronic device at least a portion of the purchase receipt data to the third site; and receiving in the second programmable electronic device from the third site use enabling data associated with the software product that enables the software program to be run on the second programmable electronic device. In one implementation the second site and the third site are the same site.

In accordance with other implementations, methods are provided that comprise receiving in a first programmable electronic device a demonstration software product from a first site and identification data of the first site, the software product comprising a software program having one or more use restrictions; transmitting from the first programmable electronic device to a second programmable electronic device the demonstration software product and the identification data of the first site; establishing by use of the identification data of the first site and/or information within the software product a communication between the second programmable electronic device and the first site; purchasing from the first site by use of the second programmable electronic device a software program use license or other use modality and receiving in the second programmable electronic device from the first site purchase receipt data; initiating, by use of the receipt data and/or executable instructions associated with the demonstration software product, a communication between the second programmable electronic device and a second site different from the first site, and transferring from the second programmable electronic device at least a portion of the purchase receipt data to the second site; and receiving in the second programmable electronic device from the second site use enabling data or license activation data that enables the software program to be run on the second programmable electronic device without one or more of the restrictions.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a block diagram of a system for the on-line sale of software products use licenses and corresponding processes, according to some embodiments of the invention;

FIG. 2 is a flow chart of implementing a software component, according to an embodiment of the invention;

FIG. 3 is a flow chart of purchasing a use license, implemented by the software component, according to an embodiment of the invention;

FIG. 4 is a flow chart of purchasing and activating a use license, implemented by the software component, according to an embodiment of the invention;

FIG. 5 is a block diagram of a system for the on-line sale of software products and corresponding processes, according to various implementations;

FIG. 6 is a block diagram of a system for the on-line sale of software products and corresponding processes, according to various implementations;

FIG. 7 is a block diagram of a system for the on-line sale of software products and corresponding processes, according to various implementations;

FIG. 8 is a block diagram of a system for the on-line sale of software products and corresponding processes, according to various implementations;

FIG. 9 is a block diagram of a system for the on-line sale of software products and corresponding processes, according to various implementations;

FIG. 10 is a block diagram of a system for the on-line sale of software products and corresponding processes, according to various implementations;

FIG. 11 is a block diagram of a system for the on-line sale of software products and corresponding processes, according to various implementations;

FIG. 12 is a block diagram of a system for the on-line sale of software products and corresponding processes, according to various implementations;

FIG. 13 is a block diagram of a system for the on-line sale of software products and corresponding processes, according to various implementations;

FIG. 14 is a block diagram of a system for the on-line sale of software products and corresponding processes, according to various implementations;

FIG. 15 is a block diagram of a system for the on-line sale of software products and corresponding processes, according to various implementations;

FIG. 16 is a block diagram of a system for the on-line sale of software products and corresponding processes, according to various implementations;

FIG. 17 is a block diagram of a system for the on-line sale of software products and corresponding processes, according to various implementations;

FIG. 18 is a block diagram of a system for the on-line sale of software products and corresponding processes, according to various implementations;

FIG. 19 is a block diagram of a system for the on-line sale of software products and corresponding processes, according to various implementations;

FIG. 20 is a block diagram of a system for the on-line sale of software products and corresponding processes, according to various implementations;

FIG. 21 is a block diagram of a system for the on-line sale of software products and corresponding processes, according to various implementations;

FIG. 22 is a block diagram of a system for the on-line sale of software products and corresponding processes, according to various implementations; and

FIG. 23 is a block diagram of a system for the on-line sale of software products and corresponding processes, according to various implementations.

### DETAILED DESCRIPTION

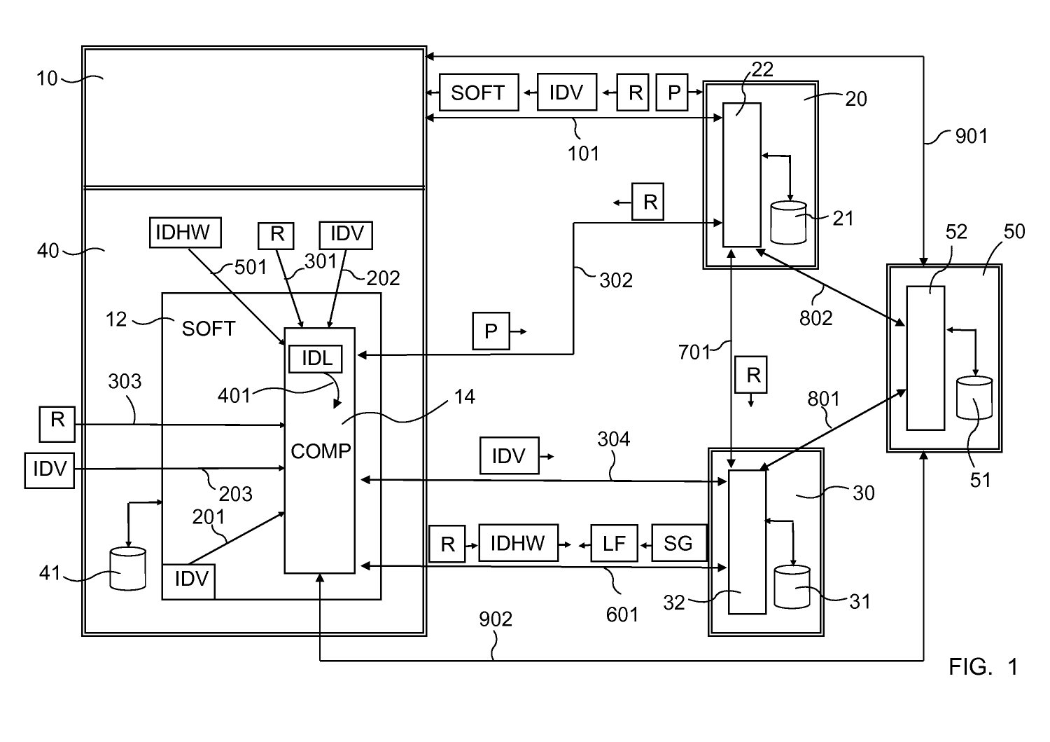

FIG. 1 shows a basic process of a method for the on-line sale of software product use licenses, according to an embodiment of the invention, including embodiment variants.

In this example, the data network in which the process is installed is the Internet. The system is made up of a plurality of manufacturing companies each having a licensing website, a plurality of distribution companies each having a vendor website where a software product 12 of the manufacturing companies are offered, and a plurality of computers connected to Internet forming potential acquisition sites for the on-line acquisition of software products offered by the vendor sites.

The invention also provides the possibility that the acquisition sites are hosting servers which acquire and install the software product 12 to then later grant rental licenses to a plurality of users having access to said server.

The software product(s) (SOFT) 12 are typically computer programs, being able to be entire programs, an installation program which installs a computer program or downloads the installation files from a computer program, upgrades or updates of programs that are already installed, etc. These software products 12 shall hereinafter be generically referred to as programs 12.

The manufacturing companies adhering to the online sale of software product use license system (hereinafter referred to as system) in order to be able to sell their programs incorporate with their program 12 a software component (COMP) 14 that is specific for the system. The software component 14 operation can be identical for all of manufacturing companies. To distinguish between different licensing and/or vendor sites, modifiable properties of the component 14 that can be modified during programming are used. The software component 14 shall hereinafter simply be referred to as component 14.

The component 14 can refer to an encapsulated group of classes and processes with their corresponding properties, which allows by interface or integration thereof in a third party application and within the execution environment of said application, the execution of certain functionalities which are predefined in the component. It can be presented in the form of an executable file or dynamic library which is included or invoked from a third party application, during the design of said application. According to an aspect of the embodiment, component incorporation refers to interfacing and/or integrating. The ways of including a component within an application may vary according to the programmer or the environment in which the application is programmed, the following ways of doing so being the most common examples: (1) including the component from a graphic menu. The programmer drags the component (graphic representation thereof) from the toolbox of the programming environment and inserts the component in the form of the application. From that moment on, the programmer has access to the component properties and can modify them and/or invoke the methods that have been described in the component; (2) including the component from source code. The programmer includes the code lines necessary for invoking the component (whether it is in library or executable form) within the source code block belonging to a form of the application. From that moment on the programmer has access to the component properties and can modify them and/or invoke the methods which have been described in the component.

One skilled in the art of programming can implement the processes of including and using the component with a program, therefore it is not considered necessary to further describe them.

The component interacts with the program, for example, by a series of functions or methods. In this example, the two most important methods, which will be described below, are the method which allows carrying out the purchase of a license on-line (FIG. 1, reference 302) and the method which allows activating a license (FIG. 1, reference 601).

During the purchasing process, the component shows a series of displays (graphical interface) for selecting the type of use license which is desired to be acquired and/or introducing the data needed to purchase the license.

The use license which the user purchases can be of several types. For example, it can be an indefinite license giving the purchaser the right to use the program for an indefinite time period, or a temporary license allowing use of the program for a limited time period. The use license also may or may not include the right for the user to update the program with the new versions thereof launched in the future. Therefore, for example, a temporary use license may allow the use of the program for one year, together with the new program updates that come out during that same year.

The system may be supervised by a single supervising site controlled by a supervising entity. Although the system embodiments are not limited to such a configuration and a plurality of supervising sites can be provided. The manufacturing companies which adhere to the system request the supervising site to register their licensing site, identify the programs which they wish to sell on-line and define the condition for the sale thereof. The distribution companies that wish to offer on their sites the programs of the manufacturing companies request in the supervisor site to register their vendor site. A licensing site and a vendor site can agree, in the supervising site, on the conditions of the sale of a program, for example, the sale price and the part that will correspond to each of them. According to an embodiment, the supervising site provides the component to the licensing sites so that the component can be incorporated with the programs. The vendor sites can obtain the programs directly from each licensing site, or through the supervising site (as the case may be), and host the programs for downloading on-line by the purchasers.

In addition to the component supplied to the licensing sites so that the component can be incorporated with their programs, the supervising site may also provide specific applications which are installed in the licensing sites and in the vendor sites for implementing the different communications of the sale process, which will be described below. These applications are not described in detail, as a person skilled in the art would have no difficulty in carrying the communications.

The incorporation of a single supervising site in the system is advantageous because it offers system reliability insurance to the different participants in the sale process. However, the system may also work without the intervention of a supervising site.

FIG. 1 is a block diagram of a system for the on-line sale of software products use licenses and corresponding processes, according to the embodiments of the invention. The user operates from a computer 40 having a communication interface 10 for communicating with Internet and a storage containing a local license database 41. In this example, the communication interface 10 of the computer 40 itself form the acquisition site from which a program SOFT is acquired on-line and the computer 40 forms the equipment where the program SOFT will be executed. However, process according to the invention is also applied to the case in which the program SOFT is acquired on-line operating from one computer and then said program SOFT is installed and executed in another computer. The other elements involved in this example are a vendor site 20, a licensing site 30 and a supervising site 50, which as mentioned above is optional, each of them provided with a main webpage, respectively 22, 32, 52, and a database, respectively 21, 31, 51.

The user sets up communication with the vendor site 20 from the acquisition site 10. This communication can be direct communication 101 or indirect communication 901 through the supervising site 50. In the latter case, the supervising site 50 deals with authenticating the identity of the acquisition site 10 as a user of the system, or it registers the user if the user is new, and may also set up a communication 802 with the vendor site 20. The user chooses a program SOFT offered on the vendor site 20 and downloads the program SOFT into the acquisition site 10 during direct communication 101. Identifying data IDV of the vendor site 20, for example, including the URL address of the vendor site 20, are transmitted along with the download. The transmission of this identifying data IDV can be done in different ways.

Preferably, the program SOFT is contained in a single downloadable file and the data IDV are included as metadata of this file. The inclusion of these data IDV as metadata of the downloadable file is usually done on each vendor site, before the download or during the download. The metadata of a file are data containing formal information of the file, such as the name, size, file type, modification date, owner, etc. For example, in the MICROSOFT WINDOWS environment, these metadata are visible from the File>Document Properties menu in the graphical interface of WINDOWS applications. The location containing these metadata in the file has several fields which are currently free or can be free, and which are used by the process according to the embodiments of the invention for storing the data IDV. It is also possible to define new properties for a file, for example, by using the MICROSOFT DSOFile.dll library. When this preferred solution is used, the data IDV are read by the component COMP as metadata of the file containing the program SOFT, as shown in 201 in FIG. 1.

An alternative solution for transmitting the data IDV includes storing them in an independent file that is downloaded together with the program SOFT. In this case, said independent file is installed in the equipment 40 together with the program SOFT and the data IDV are read by the component COMP in said independent file, as is shown in 202 in FIG. 1.

Another alternative solution includes the vendor site 20 providing the user with a code IDV, for example, by an on-screen display or by sending an e-mail, during the program SOFT downloading process, and the user then furnishes said code IDV to component COMP at the request of the latter, as is shown in 203 in FIG. 1.

If the user downloads a program SOFT of the type not having a trial period, the user purchases the program SOFT by an on-line payment P on the vendor site 20, during the communication 101, and in exchange receives a purchase receipt R containing, either explicitly or by reference, identifying data of the vendor site 20 and information on the type of license acquired. Therefore, both the IDV, for example, containing the URL address of the vendor site 20, and the purchase receipt R have been transmitted in this case from the vendor site 20 to the acquisition site 10. The transmission of the purchase receipt R can be done in the form of an independent file downloaded together with the program SOFT and it is then read by the component COMP, as is shown in 301 in FIG. 1, or by a code furnished to the user, for example, by an on-screen display or by sending an e-mail, which is then furnished to the component COMP at the request of the latter, as is shown in 303 in FIG. 1.

If the user downloads a program SOFT of the demonstration version type, which is operative for only the trial period, then the purchase P is not made during the communication 101. In this case there is no purchase receipt R; only the data IDV, for example, containing the URL address of the vendor site 20, are transmitted from the vendor site to the acquisition site 10.

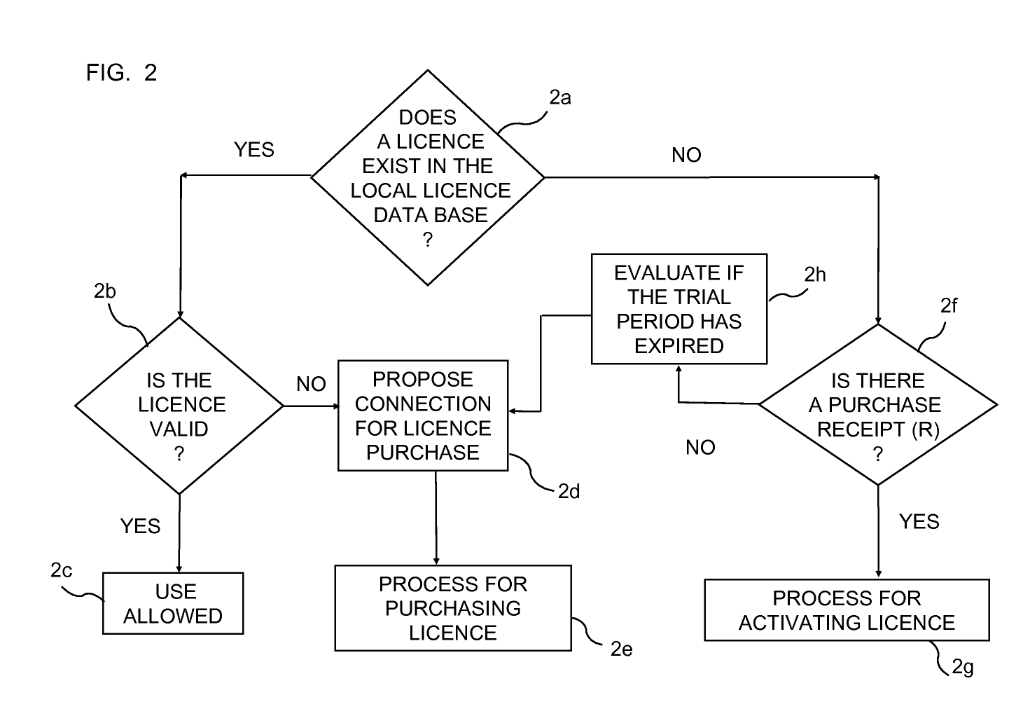

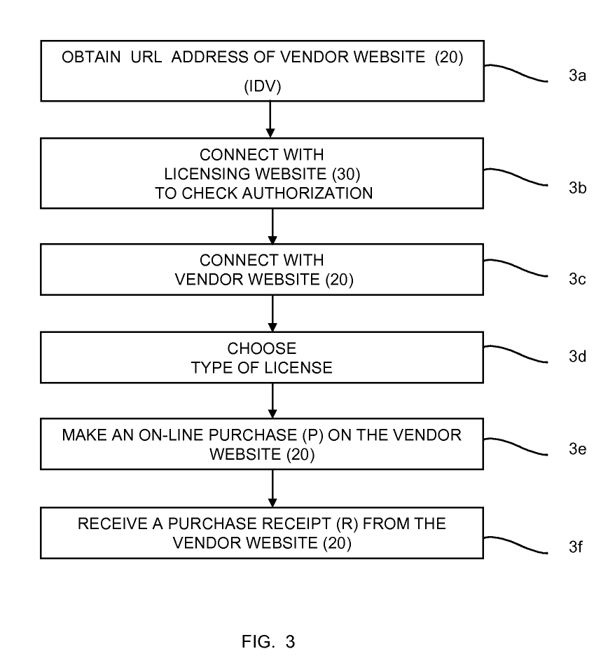

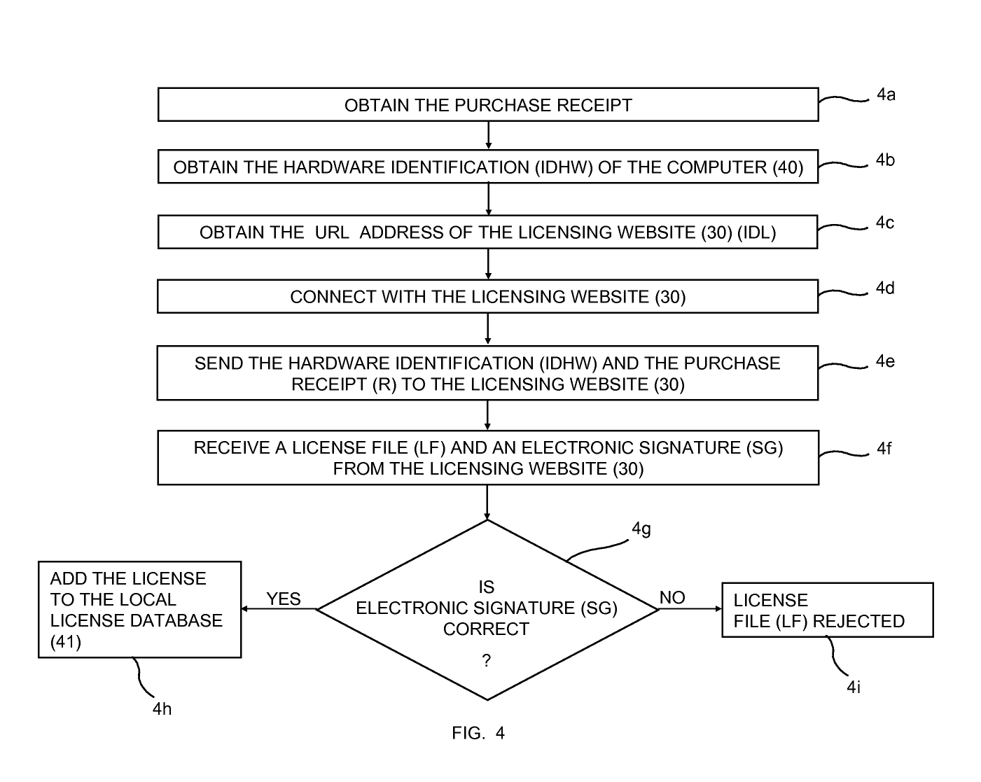

When the program SOFT is executed in the computer 40, component COMP is executed performing the actions shown in FIG. 2. First, 2a verifies if in the local license database 41 there is a use license for the program SOFT. If the license exists, 2b verifies if it is valid. If it is valid, 2c authorizes the use of the program. If it is not valid, 2d proposes a connection with the vendor site 20 to purchase a license. The component COMP locally accesses the identifying data IDV of the vendor site 20, which for example includes the URL address of the vendor site, by one of the processes 201, 202 or 203 explained above. If the user agrees, 2e launches the process for purchasing a license described below and shown in FIG. 3. If, at 2a, the license does not exist, 2f verifies if the purchase receipt R exists, which is accessed locally by one of the processes 301 or 303 explained above. If the purchase receipt R exists, 2g launches the process for obtaining and activating the license described below and shown in FIG. 4. If the purchase receipt R does not exist, 2h evaluates if a demonstration period for the program SOFT has expired. If the demonstration period has expired, 2d proposes a connection with the vendor site 20 to purchase a license, as described in the foregoing.

The process for purchasing a use license according to an embodiment of the invention is shown schematically in FIG. 3. In this process, the component COMP carries out the following basic actions. First, 3a locally accesses the data IDV to obtain, for example, the URL of the vendor site 20, by one of the processes 201, 202 or 203 explained above. Then, 3b sets up a communication 304 (902, 801 as the case may be) with the licensing site 30 and transmits the data IDV to the licensing site 30. The licensing site 30 checks that the vendor site 20 corresponding to the data IDV is authorized to sell the use license or authenticates the vendor site identifiers provided by the component (COMP) and, if it is authorized, returns a purchase authorization to the component COMP, after which 3c the component COMP sets up a communication 302 with the vendor site 20 and notifies the vendor site 20 that the component COMP wishes to initiate a process for purchasing a license. During this communication 302, the user can intervene through the graphical interface of the component COMP and choose the type of license most suited to the purchaser. Then, 3d chooses the type of license the component COMP wishes to purchase and 3e makes a purchase by an on-line payment P, in exchange receiving at 3f the purchase receipt R. In this example, the component COMP itself sets up the communication 302 with the vendor site 20. As an alternative, it can be provided that the component COMP shows in the graphical user interface a link to the URL address of the vendor site 20 and allows the user to set up the communication 302 through the browser of the purchaser's computer 40. Optionally, instead of setting up direct communication 302 with the vendor site 20, the component COMP can do this by indirect communication 902 with the supervising site 50 in communication with the vendor site 20 via the setup communication 802.

The process for obtaining and activating the license according to an embodiment of the invention is schematically shown in FIG. 4. In this process, the component COMP carries out the following basic actions. First, 4a obtains the purchase receipt R, which is accessed locally by one of the processes 301 or 303 explained above. The component COMP also locally access 4b hardware identifying data IDHW in the computer 40. These data IDHW are, for example, the serial number of the hard drive where the program SOFT is installed, which is read by the component COMP by the process 501 indicated in FIG. 1. The component COMP also obtains the identifying data of the licensing site IDL, for example, the URL address of the licensing site, reading the IDL by the process 401 indicated in FIG. 1. According to an aspect of the embodiments, the data IDL is incorporated in the component COMP itself Then, 4d sets up a communication 601 with the licensing site 30 and notifies the licensing site that the component COMP wishes to initiate a license activation session. In the communication 601, the component COMP at 4e sends the hardware identifying data IDHW and the purchase receipt R and in exchange receives at 4f a license file LF including the hardware identifying data IDHW, such that the license file LF will only be valid for the use of the program SOFT in said computer 40, and an electronic signature SG done with the private key owned by the licensing site 30. The component COMP owns the electronic signature public key and verifies at 4g such signature. If the electronic signature SG is correct, at 4h the component COMP adds the license file LF to the license database 41, where the component COMP stores the information of the different processes for purchasing and activating licenses in which it has been involved. If the electronic signature SG is not correct, at 41 the license file LF is rejected.

Optionally, instead of setting up direct communication 601 with the licensing site 30, the component COMP may do so by indirect communication 902 with the supervising site 50, which in turn sets up communications 801, 802 with the licensing site 30 and with the vendor site 20, which can also communicate with one another. All this is possible due to the fact that the component COMP knows the identifying data of the supervising site, for example, a URL address of the supervising site 50, and is able to provide the identifying data of the vendor and licensing sites, for example, the URL addresses of the licensing site 30 and of the vendor site 20, contained respectively in the data IDL and IDV which the component COMP accesses locally.

It can also optionally be provided to set up on-line communication 701 between the vendor site 20 and the licensing site 30, during which they exchange information relating to the acquisition of the software product SOFT. For example, this on-line communication 701 allows the licensing site 30 to know that the software product SOFT has been downloaded and/or paid for from a specific and authorized vendor site 20 before the purchaser, through the software component COMP, makes contact with said licensing site 30 to activate a use license. When a use license of software product SOFT has been purchased in an authorized vendor site 20, in said on-line communication 701 the vendor site 20 sends a copy of the purchase receipt R to the licensing site 30.

Some embodiments have may be described with respect to a process, including an apparatus and computer readable medium thereof, of on-line sale of a software product use license, by offering online, by a plurality of vendor sites, a software product to be downloaded on-line according to respective online downloading processes; selling, or offering for purchase online, a use license for said software product offered by one of said vendor sites and downloaded on-line; and activating said purchased use license on-line by a licensing site different from said vendor sites.

Some embodiments also comprise a software component as a use license activator for carrying out said process, including an apparatus and a computer readable medium thereof, by incorporating the software component with the software product; executing by an equipment said software component together with said software product for managing the activating a purchased use license for said software product by the licensing site; and associating a vendor site identifier to each of said on-line downloading processes of the software product by the vendor sites, wherein the executing software component locally accesses said vendor site identifier, locally accesses identifying data of the licensing site, and launches a process for managing the activating said purchased use license for the software product based upon the vendor site identifier and the identifying data of the licensing site. According to an aspect of some embodiments, the IDV and IDL can be any identifying information uniquely identifying a vendor site 20 and a licensing web site 30, respectively, and can be generated or provided by the vendor site 20, the licensing web site 30, the software product (SOFT) 12, the component (COMP) 14, or any combinations thereof

The described examples may be implemented in software (as stored or encoded on any known computer readable media, such as, without limitation, a compact disk, a Digital Versatile Disc (DVD), memory, a carrier wave or electromagnetic signal, etc.) and/or in any computing or information processing hardware, for example, a programmable computing device. For example, the embodiments can be implemented in a programmable electronic device that can store, retrieve, output (for example, display) and process data). For example, the embodiments can be implemented in any type of programmable computing apparatus, such as, without limitation, a personal computer, a personal digital assistant (PDA), a mobile phone, a server and/or a client computer in case of a client-server network architecture, or networked computers in a distributed network architecture.

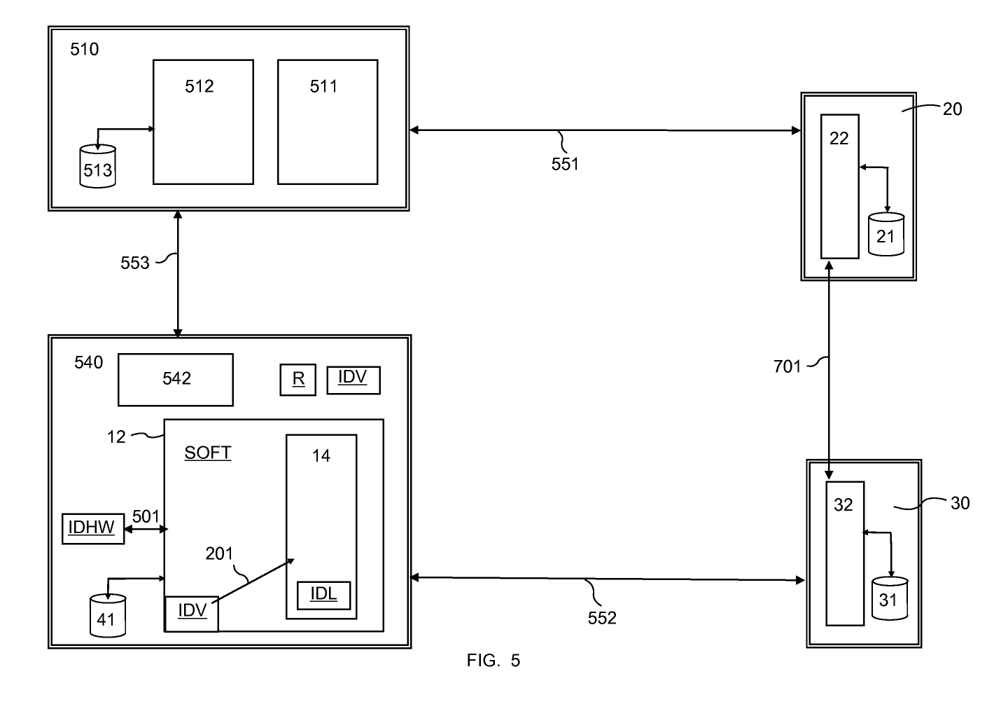

In the description to follow it is to be appreciated that although the examples of FIGS. 5-14 and 17-21 do not show the use of a supervising site 50, such use is optionally available in each of the examples to perform any of the previously explained functions and/or to participate in communications between the different devices and the vendor and/or licensing sites or to participate in the communications between the vendor site and the licensing site.

FIG. 5 shows implementations using two programmable electronic devices 510 and 540. In the example of FIG. 5, device 510 connects through communication 551 with the vendor site 20 and device 540 connects through communication 552 with the licensing site 30. Communication between devices 510 and 540 is achieved via communication 553. The means by which communication is achieved between the various components may take a variety of forms, including the use of physical or wireless networks. Moreover, communication 553 may be achieved by use of a communication protocol that uses the USB or any other communication that enables local or remote connection of the two devices 510 and 540, like, for example, via the Internet. The different communications disclosed herein may use different communication protocols belonging to different layers of the OSI model, protocols such as Ethernet, WIFI, WIMAX, CDMA, WCDMA, LTE, IP, TCP-IP, UDP, FTP, SOAP, XML and any other type of communication protocol that can be used in a data network and/or to connect different devices, such as the above USB or others such as Firewire, RS232, Bluetooth, Infrared, etc.

In one implementation, device 510 has two applications 511 and 512 running on the programmable electronic device 510 which can be used individually or in combination to access the vendor site 20, the licensing site 30 and/or to communicate with device 540. In one implementation, application 511 is a browser capable of displaying a web page 22 of the vendor site 20 and/or a web page 32 of the licensing site 30 and which enables by use of one or both of the web pages the downloading of a file to device 510 itself or to device 540, for example, by connecting device 540 to a USB port on device 510.

In one implementation, application 512 is a management application that can establish communications with the vendor site 20, with the licensing site 30 and with device 540 for the purpose of purchasing and downloading files, such as software programs. In one implementation application 512 may store information or otherwise access information in a memory device 513.

Device 540 also has an application 542 that can establish different communications, such as communications with device 510, with application 512 of device 510, with the vendor site 20 and with the licensing site 30.

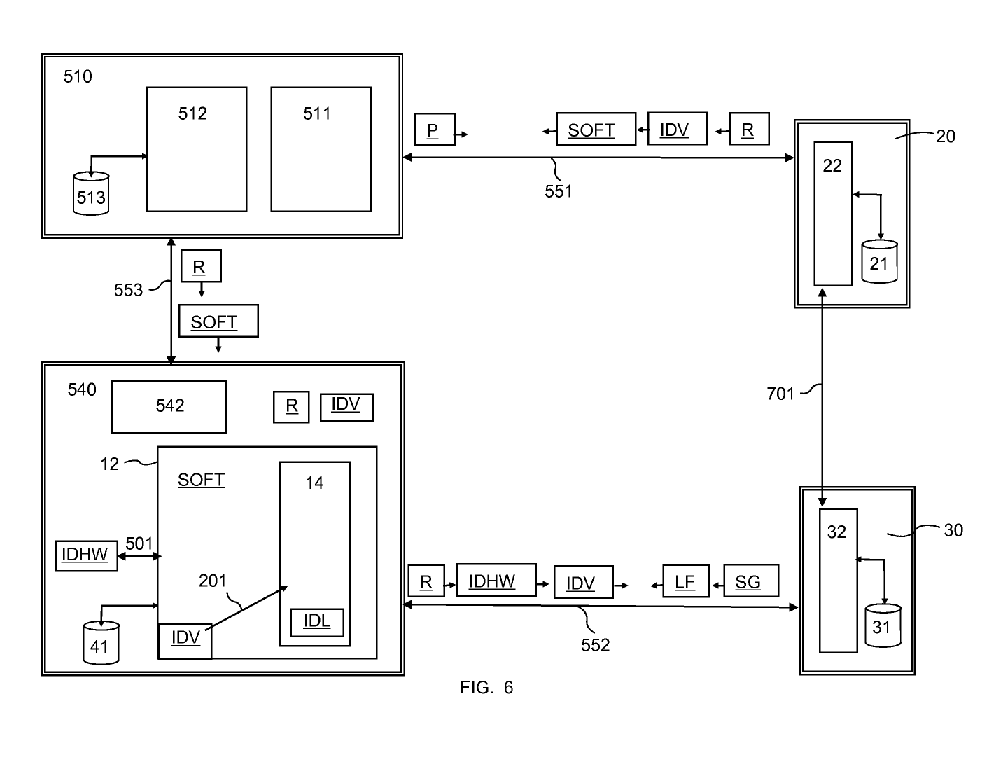

FIG. 6 shows an embodiment in which the purchase of a file (e.g. SOFT) is accomplished through device 510 and the license activation is performed from device 540. Device 510 purchases and downloads the SOFT program from the vendor site 20 through communication 551. Vendor site 20 transmits a file with the SOFT program and a receipt or proof of purchase R to device 510.

In one implementation the vendor site 20 also transmits to device 510 identification information (IDV) that identifies the vendor site. The IDV data can be transmitted as part of the SOFT file, such as metadata of the SOFT file, may form a part of the receipt, or may be delivered in another file. In one implementation, both the IDV data and the receipt data R are included within the file containing the SOFT program, for example in the form of metadata of the file. This facilitates the transmission between different devices of the file containing the SOFT program together with the receipt and IDV data, as it is only necessary to copy one file and this process can even be manually accomplished, by using for example a USB memory to transport the file from one device to another device. Although the figures used to explain the different embodiments display the SOFT, R and IDV elements as being separate, such elements can be combined in variety of ways whether in a single file, in two files or in three files.

Device 510 may purchase and download the SOFT program as well as receive the receipt data R and IDV identification data using, for example, the browser application 511 and/or the management application 512 and store the downloaded data in memory device 513. All, or a portion of the data downloaded (SOFT program, receipt data R, IDV data, etc.) in device 510 may then be transmitted via communication 553 to device 540.

In one implementation, at a time when the SOFT program has been downloaded, installed or is running on device 540, a license activation process similar to one of those explained in conjunction with FIG. 1, for example, may be implemented. For this purpose, a COMP component, which may be incorporated in the SOFT program, transmits to the licensing site 30 identification data of device 540, such as IDHW data associated with a hardware element of device 540, along with the receipt data and the IDV identification data. The licensing site 30 may then communicate via communication 701 with the vendor site 20, to verify, for example, if the receipt data is correct. Upon a successful verification of the receipt data, the licensing site 30 then transmits data to device 540 to enable the use of the SOFT program, such as by enabling the activation of a license. This may be accomplished in a variety of ways, such as, for example, transmitting a file LF and an electronic signature SG to device 540 where the COMP component receives and stores the data in memory device 41.

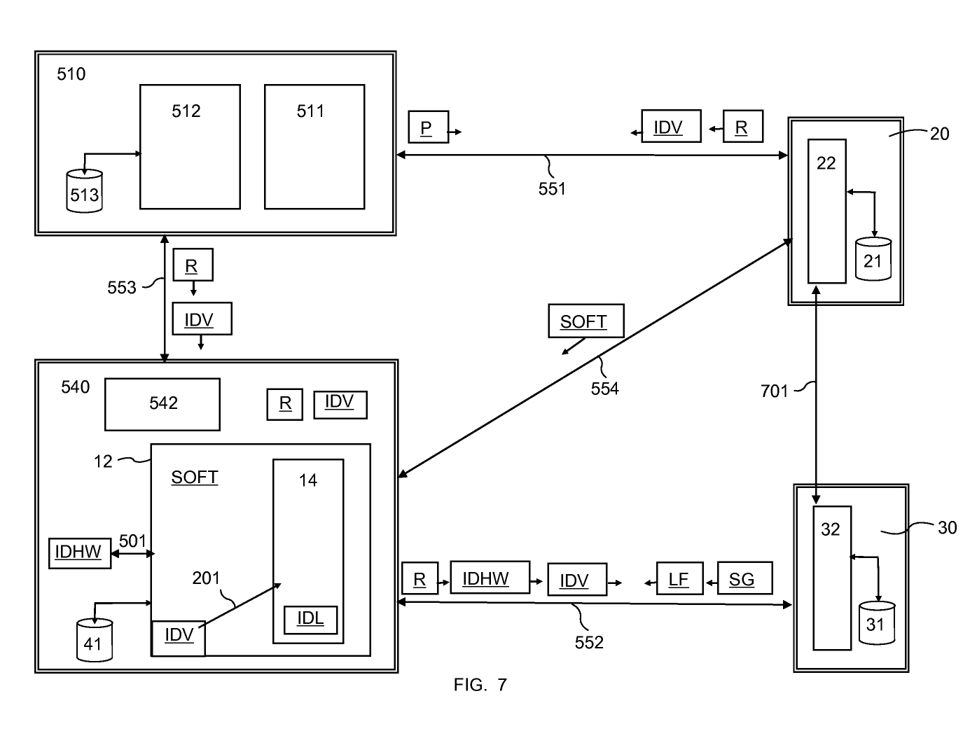

FIG. 7 shows an embodiment in which device 510 purchases a file (e.g. SOFT program) from vendor site 20 and the device 540 downloads the file from the vendor site 20 and activates a use license, or other use enabling modality, from the licensing site 30. Device 510 performs an online purchase of SOFT program with the vendor site 20 through communication 551 and in return receives receipt data R and IDV identifying data from the vendor site 20. Thereafter, device 510 transmits the receipt data and the IDV data to device 540 by using, for example, a communication 553 between applications 512 and 542. Application 542 then establishes a communication 554 with the vendor site 20 to download the SOFT program acquired by device 510 by transmitting to the vendor site the receipt data and optionally the IDV data. In one implementation, once the SOFT program is downloaded to device 540, the SOFT program runs on device 540 and activates the license by means of a communication with the licensing site 30 as explained above in conjunction with FIG. 6.

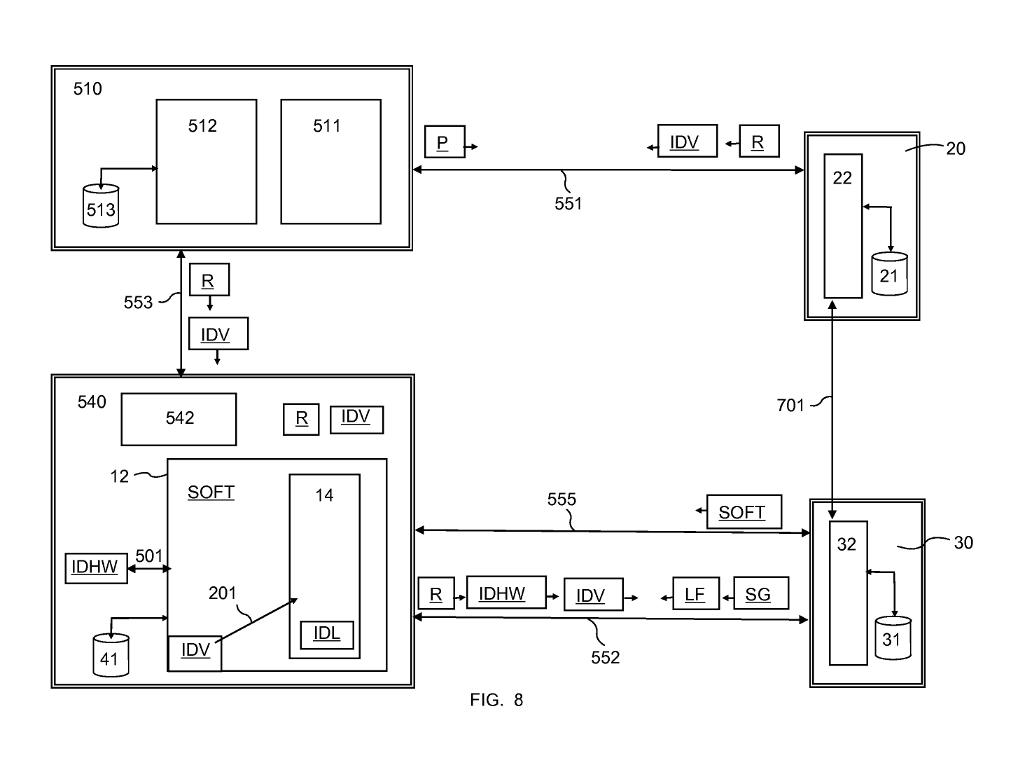

FIG. 8 shows an embodiment in which device 510 acquires a license, or other use enabling modality, to use a software product (e.g. SOFT program) from vendor site 20 with device 540 downloading the file containing the SOFT program and activating the license from the licensing site 30. In one implementation, for example, device 510 performs an online purchase of a license through communication 551 with the vendor site 20. In return, device 510 receives receipt data R and IDV identifying data from the vendor site 20. Device 510 then transmits the receipt data and the IDV data to device 540 by using, for example, a communication 553 between applications 512 and 542. Device 540 then establishes communication 555 with the licensing site 30 and by use of the IDV data and/or by use of the receipt data R initiates a download of the SOFT program to device 540 from the licensing site 30. In one implementation, once the SOFT program is downloaded to device 540, the SOFT program runs on device 540 and performs, by use of, for example a COMP component, the license activation via a communication with the licensing site 30. In one implementation the license activation is performed in a manner similar to that explained above in conjunction with the description of FIG. 6.

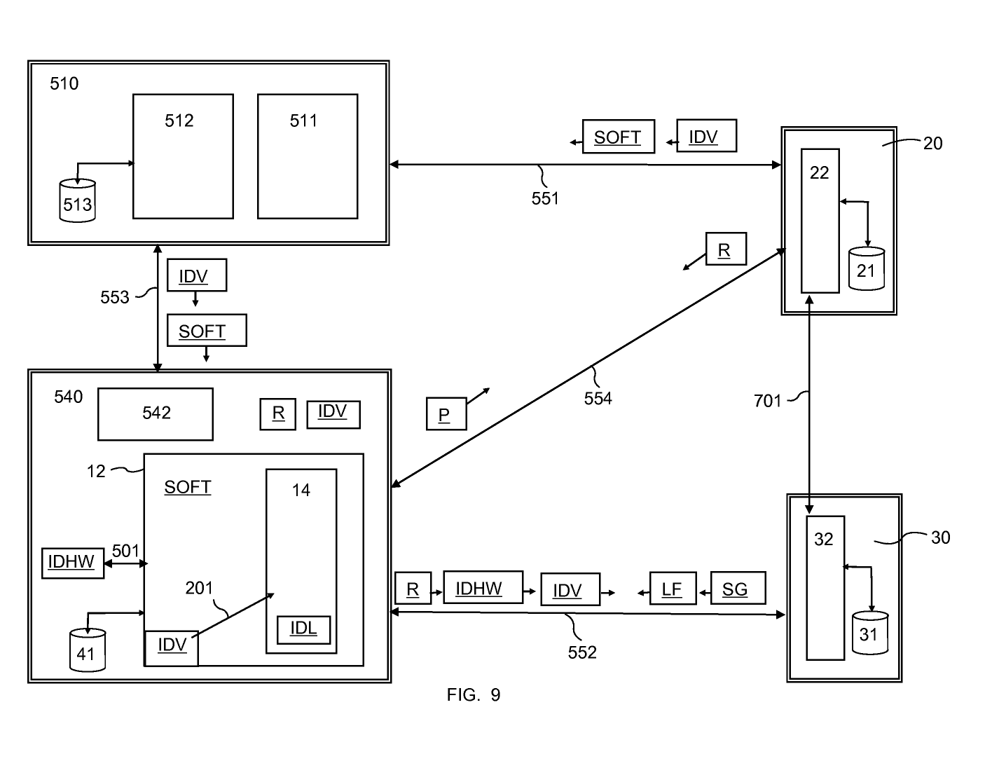

FIG. 9 illustrates implementations in which device 510 downloads the SOFT program from the vendor site 20 and device 540 performs the purchase of the SOFT program in the vendor site 20 and activates the license from the licensing site 30. In one implementation the process begins with the transmission of the SOFT program file and IDV data of vendor site 20 to device 510. Subsequently device 510 transmits the SOFT program and IDV data to device 540.

In an implementation of FIG. 9, and also with respect to any of the other implementations disclosed herein, the SOFT program may be, for example, a demo version that allows its use for a limited time. The SOFT program may be, for example, a free program that includes certain features that are disabled, or otherwise inaccessible for use, until a purchase fee or other remuneration (e.g., earned credit, coupon, etc.) is exchanged to permit the use of such features.

In one implementation, after the SOFT program is installed or running on device 540, the COMP component can display a message for the user asking if he or she wishes to purchase the program. If a purchase is requested by a user the component COMP initiates an online purchase of a license, or other use enabling modality, to use the SOFT program via communication 554 with the vendor site 20 and then activates the license, or otherwise enables the use of the SOFT program, via communication 552 with the licensing site 30.

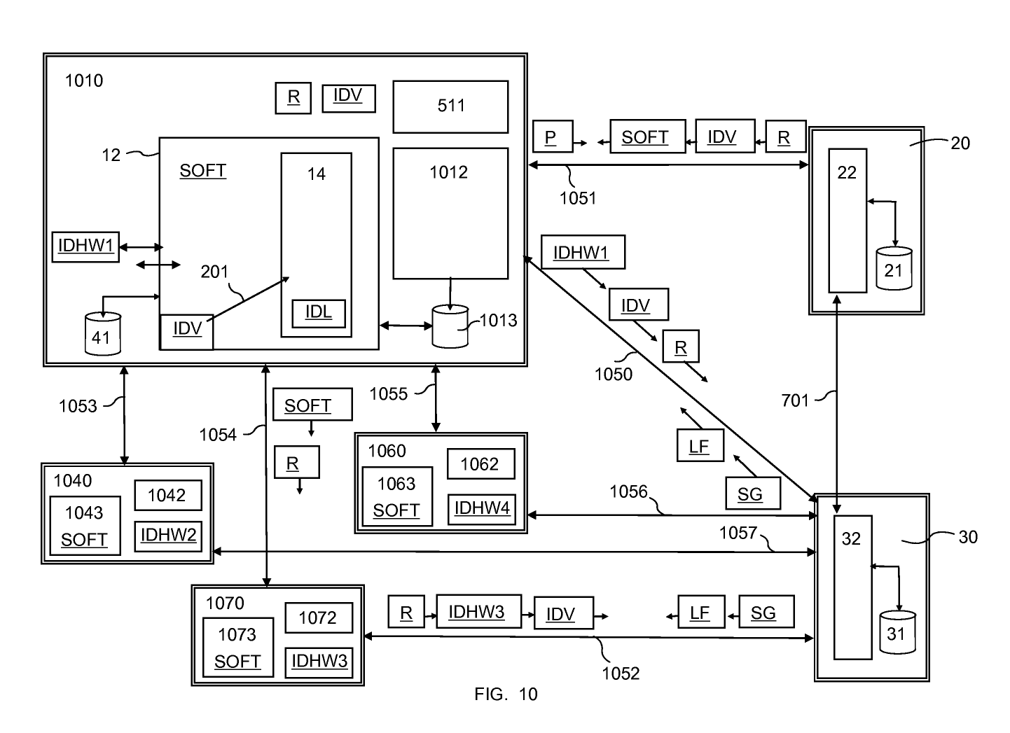

FIG. 10 shows an embodiment in which a device 1010 acquires and downloads a SOFT program from vendor site 20 through communication 1051. In one implementation device 1010 is a device that can install and run the SOFT program, as well as transmit it to other devices 1040, 1070 and 1060, through communications 1053, 1054 and 1055, respectively. In one implementation each of devices 1010, 1040, 1070 and 1060 has identifying data of the relevant device IDHW1, IDHW2, IDHW3 and IDHW4 respectively, these being, for example, data associated with a hardware element of each device.

Device 1010 may use, for example, the same operating system or an operating system that is compatible with the operating system of the devices 1040, 1060 and 1070. In another embodiment, the device 1010 may use a different operating system from one or more of the operating systems of devices 1040, 1060 and 1070, and the SOFT program can run on a virtual machine running on device 1010. For example, the SOFT program may be a program developed in Java that runs on a Java virtual machine in the device 1010. In yet another embodiment, device 1010 may have emulation software that emulates the hardware and/or software of devices 1040, 1060 and 1070 and the SOFT program can run on the emulation software of device 1010.

In one implementation, device 1010 acquires the SOFT program from the vendor site 20 through communication 1051 using, for example, a browser application 511 and/or a management application 1012. In one implementation the management application 1012 has operating features that facilitate the purchasing and downloading of the SOFT program and also for storing associated information in a memory device 1013.

In one implementation, after the SOFT program is downloaded, installed or run on device 1010, the COMP component initiates contact with the licensing site 30 to activate the license, or other use enabling modality, through communication 1050, by transmitting for example IDHW1 information to the licensing site along with the receipt data R and IDV data. In one implementation, the licensing site 30 in return transmits to device 1010 a license or license activation data, such as through a license file LF and an electronic signature SG.

In one embodiment of the present invention, the license purchased by the device 1010 in the vendor site 20 can enable the use of the SOFT program in a specific number of devices, such as 2, 3, 4 or more devices. For example, device 1010 may select the number of devices on which to run the SOFT program during an online purchasing activity with vendor site 20. In another example, the SOFT program may run on a fixed number of devices, for example 5, and if the user wants to use it on more devices another online purchase must be made and another receipt R2 different from the receipt R must be acquired.

Information regarding the number of devices that can use the SOFT program may be included, for example, in the receipt R. The receipt R may also include an electronic signature from the vendor site to prevent the modification of the receipt data in a manner that alters the number of devices authorized to run the SOFT program.

Each of devices 1040, 1060 and 1070 may have an application 1042, 1062 and 1072, respectively, allowing them to communicate with device 1010, for example with application 1012 of device 1010, to receive the SOFT program along with the receipt R and IDV data (not shown in FIG. 10), by way of example, in communication 1054. As illustrated in FIG. 10, the SOFT program may be installed in devices 1040, 1070 and 1060 by means of applications 1043, 1073 and 1063 on the respective devices.

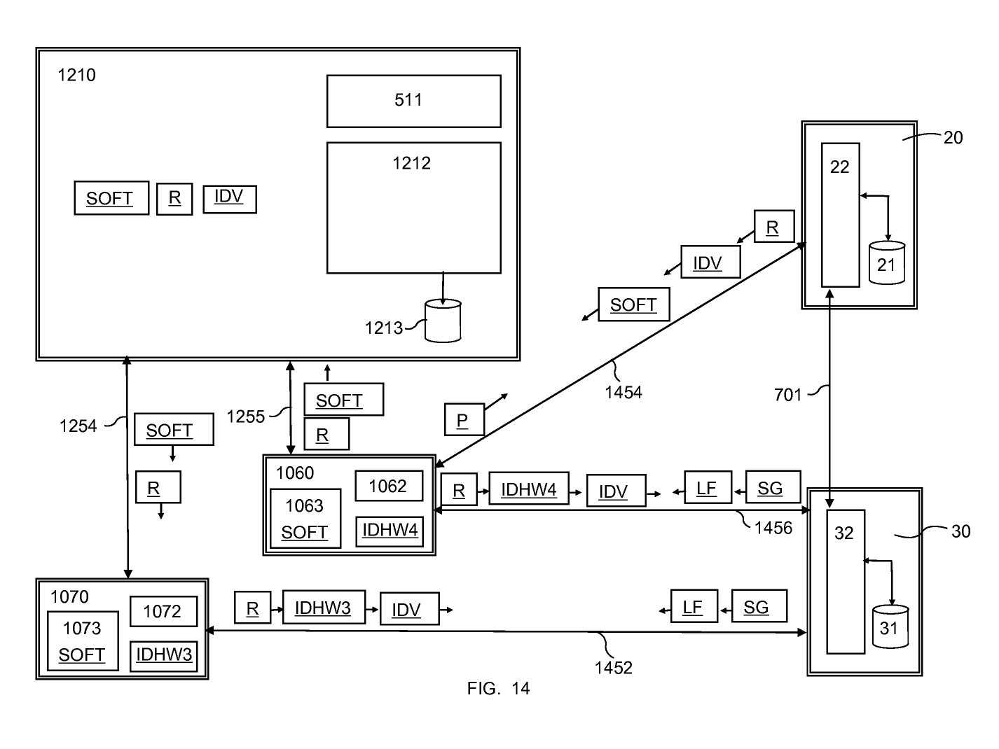

In other implementations one or more of applications 1042, 1062 and 1072 may enable devices 1040, 1060 and 1070 to perform online purchasing at vendor site 20, to receive the SOFT program from vendor site 20 and to transmit the SOFT program along with the receipt data and IDV data to other devices, so that the purchase of the SOFT program can be made from any of the devices 1010, 1040, 1060 and 1070. FIG. 14 shows an example of this type of implementation.

In an embodiment of FIG. 10, each device running the SOFT program may perform license activation through a communication with licensing site 30. For example, FIG. 10 shows communication 1052 used by device 1070 to activate the license, or otherwise enable the use in device 1070, of the SOFT program. For this purpose, after the SOFT program is downloaded or installed on the device 1070, a COMP component associated with the SOFT program communicates with licensing site 30 to activate the license, for example by transmitting to the licensing site IDHW3 information identifying the device 1070 along with the receipt data and IDV data, while receiving the license from the licensing site, for instance through a license file LF and an electronic signature SG. Similarly, devices 1040 and 1060 can activate the licenses for their respective SOFT 1043 and SOFT 1063 programs via communications 1057 and 1056 respectively.

In one implementation licensing site 30 stores in a database 31 the information pertaining to the activated licenses for each device associated with the receipt data R and IDV data, and allows different devices to activate licenses to use the SOFT program until reaching the maximum number of devices allowed (e.g., the number of devices specified in the receipt R).

In one implementation licensing site 30 also enables a SOFT program license to be transferred from one device to another. In order to do so, the license on the device on which the SOFT program is not to be used is disabled, thus freeing a SOFT program license associated with the receipt data R in database 31 of the licensing site 30 so that a license may be made available and activated in another device. This advantageously enables software applications that have been purchased to be transferred from one hardware device to another, and has particular applicability to hardware devices that are commonly exchanged, such as, for example, mobile phones, laptops, etc.

For example, in an implementation of FIG. 10, device 1010 may disable its SOFT program license. This may be accomplished by the COMP component 14 associated with the SOFT program displaying an option in a user interface that when selected by a user implements instructions on the device 1010 to disable the license to use the SOFT program associated with the receipt R. Disabling of the license may be achieved in a variety of ways. In accordance with one method the LF file and/or SG files stored on device 1010 are deleted in conjunction with establishing communication with the licensing site 30 to transmit information indicating that the license to use the SOFT program has been disabled in device 1010.

The information transmitted by device 1010 to the licensing site 30 to indicate that the license to use the SOFT program has been disabled on the device 1010 may include, for example, the receipt information, the IDHW1 data identifying device 1010, IDV data, a date and time when the license was disabled or any combination of the aforementioned data.

In another implementation application 1012 may be used in lieu of the COMP component to disable the SOFT program license in device 1010 in a similar way to that explained in the preceding paragraph. One advantage of application 1012 disabling the SOFT program license is that application 1012 can be used to acquire different programs, thus allowing the centralized management of licenses for different programs. For example, when device 1010 is to be replaced by a new device, the application 1012 may disable all software licenses that were activated in device 1010 and that are no longer to be used, whereby, upon releasing these licenses on the licensing site, the new device replacing device 1010 can use the released licenses.

In yet another embodiment, a SOFT program license may be disabled by means of a communication between application 1012 and component 14. For example, component 14 may have a license disabling function that includes a set of executable instructions that when executed disable the SOFT program license on device 1010. Application 1012 can call this disabling function so that the COMP component disables the license. This embodiment has the advantage that the deactivation of the license is done through a set of instructions which can be specific to each SOFT program, thus preventing piracy or illegal copying of the SOFT program. In addition, this embodiment allows application 1012 to centrally manage software license disabling for all software installed on the device 1010 with a component that includes a license-disabling function, thus facilitating the replacement of device 1010 with a new device without losing the licenses of the purchased programs.

Although the example shown refers to the license disabling of the SOFT program on device 1010, this example can also apply to devices 1040, 1070 and 1060 in which the SOFT program license disabling can be done by use of the COMP component running on the devices and also using applications 1042, 1072 and 1062, in a similar way to application 1012 described in the previous example.

Optionally, the communication between devices 1010, 1040, 1060 and 1070 and the licensing site 30 can be indirect communications through the vendor site 20, or through an intermediary site (not shown).

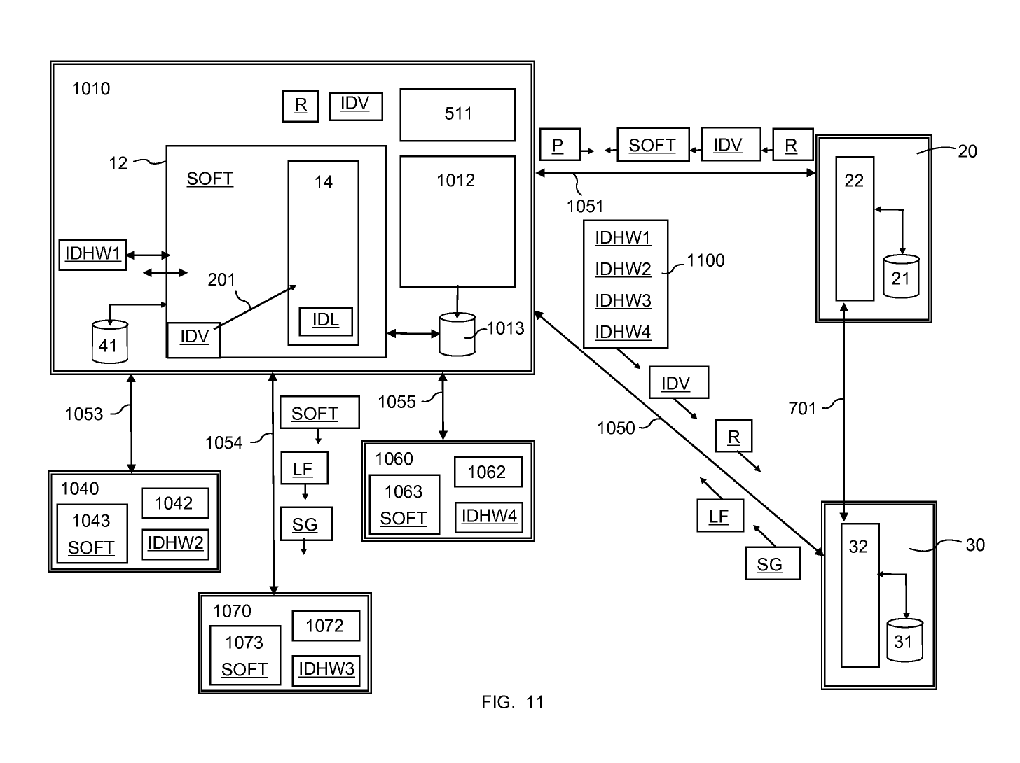

FIG. 11 shows other embodiments in which the activation of the SOFT program license in devices 1040, 1070 and 1060 is performed from device 1010. In the example of FIG. 11, the activation of the license for the different devices can be performed by the COMP component running on device 1010. For example, the COMP component can access database 1013 containing the IDHW1, IDHW2, IDHW3 and IDHW4 information which identifies the various devices.

In one implementation, device 1010 transmits to the licensing site 30, through communication 1050, the receipt data R, the IDV data and information 1100 which includes an identification of the different devices in which the SOFT program license is to be activated. For example, such information 1100 can include the IDHW1, IDHW2, IDHW3 and IDHW4 identification data. In response, the licensing site transmits data to device 1010 that allow the SOFT program activation on the different devices identified in information 1100, such as a LF license containing the IDHW1, IDHW2, IDHW3 and IDHW4 identifying data and an electronic signature SG to verify that the LF file has been created on the licensing site. After having received the data from the licensing site 30, device 1010 subsequently transmits the SOFT program along with the LF user license and the electronic signature SG to the different devices 1040, 1060 and 1070 in which the SOFT program is to be installed. For the sake of simplicity, FIG. 11 only shows the SOFT, LF and SG elements in communication 1054.

Device 1010 can obtain the identifying information of the various devices 1040, 1060 and 1070 in a number of ways. For example, application 1012 of device 1010 can communicate with applications 1042, 1072 and 1062 to receive the identifying data IDHW2, IDHW3 and IDHW4, respectively, and store this information in database 1013.

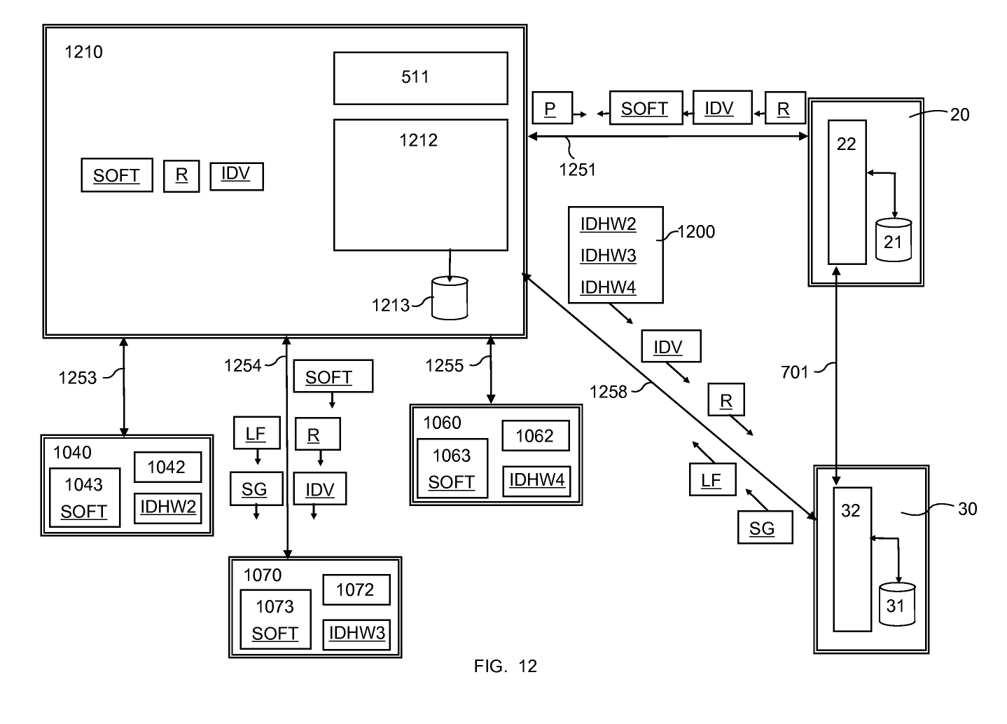

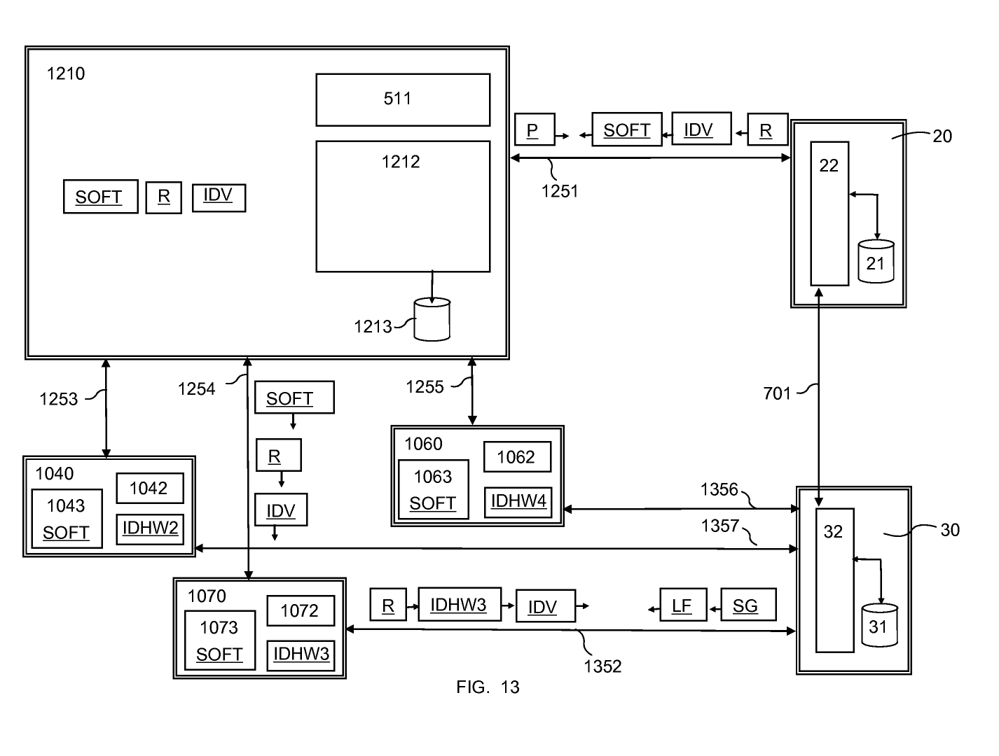

FIGS. 12 and 13 show other embodiments of the present invention in which the SOFT program is acquired from a device 1210 that does not run the SOFT program. For example, the SOFT program can be installed and run on the devices 1040, 1060 and 1070 while the device 1210 acquires and stores a copy of the file containing the SOFT program along with the receipt data R and IDV data, without installing or running the SOFT program. In one embodiment, device 1210 uses for example an operating system that does not allow the SOFT program to be run.

The device 1210 can purchase software online by using communication 1251 with the vendor site 20. A browser type application 511 and/or a purchase and download management application 1212 installed on device 1210 may be used for this purpose. Information associated with the purchase and/or download of a software product may be stored in a database 1213. Device 1210 communicates with devices 1040, 1070 and 1060 using communications 1253, 1254 and 1255, respectively, and transmits a file containing the SOFT program to these devices so they may install and/or run the SOFT program.

The examples shown in FIGS. 12 and 13 differ insofar as in FIG. 12 the activation of the license in the devices in 1040, 1070 and 1060 is performed using a communication 1258 between the device 1210 and licensing site 30, whereas in FIG. 13 the SOFT program license activation in the devices 1040, 1070 and 1060 is done through communications 1357, 1352 and 1356, respectively, with the licensing site 30.

With reference to FIG. 12, in one implementation device 1210 establishes a communication 1258 with the licensing site 30 to activate the license to use the SOFT program in devices 1040, 1070 and 1060. For this purpose, device 1210 transmits information 1200 to the licensing site containing identification data IDHW1, IDHW2 and IDHW3 of these devices, along with the receipt data R and IDV data, while receiving data for the license activation in such devices, for example a LF license file that contains the identifying data IDHW2, IDHW3 and IDHW4 and an electronic signature SG.

After receiving the data from licensing site 30, device 1210 subsequently transmits the LF and SG files to devices 1040, 1070, and 1060 so that the COMP component associated with the program SOFT program may be used to activate the license upon reading the LF and SG files. The license activation process can be conducted through a direct or indirect communication between the devices 1040, 1070 and 1060 and the licensing site 30.

For example, in one implementation when device 1210 performs the SOFT program purchase, it transmits the SOFT program to device 1070 together with the receipt data and IDV data. Once the SOFT program is downloaded, installed, or running on the device 1070 the COMP component associated with the SOFT program detects that the license is not activated in device 1070 and establishes communication with the licensing site 30 via an indirect communication passing through device 1210.

In one embodiment, application 1212 establishes the indirect communication between the device 1070 and the licensing site 30. This may be accomplished in a variety of ways, such as, for example, application 1212 communicating with the licensing site 30 by means of communication 1258, communicating with the SOFT program or the COMP component associated with the SOFT program, or communicating with the application 1072 of device 1070.

In other implementations, as illustrated in FIG. 13, a license activation in devices 1040, 1070 and 1060 is performed by using communications 1357, 1352 and 1356 that directly communicate such devices with the licensing site 30, for example, through the Internet.

In one implementation, device 1210 transmits the SOFT program with the receipt data R and the IDV data to device 1070. After the SOFT program has been downloaded, installed, or run in device 1070 the COMP component associated with the SOFT program is used to activate a SOFT program license through communication 1352 with the licensing site 30.

FIG. 14 shows another embodiment in which a SOFT program is acquired and downloaded directly from device 1060, with device 1210 enabling or otherwise facilitating a transmission of the SOFT program to device 1070 so that it may also be used in device 1070.

In one implementation, device 1060 acquires the SOFT program through communication 1454 with the vendor site 20 and activates the license via communication 1456 with the licensing site 30. Subsequently, the device 1060 transmits the SOFT program with the receipt data R and the IDV identifying data (not shown) to device 1210 via communication 1255. In one implementation the receipt data R permits the activation of the SOFT program license in multiple devices.

The SOFT program and the receipt data R is then transmitted to device 1070 through the communication 1254. When the SOFT program is downloaded, installed or run on device 1070, the COMP component associated with the SOFT program establishes a communication 1452 with the licensing site 30 to activate the license of the SOFT program on the device 1070.

Although the embodiments of FIGS. 10 to 14 show the SOFT program being downloaded only from the vendor site 20, other combinations are possible. For example, in alternative implementations the SOFT program is downloaded from other sites, such as from the licensing site 30.

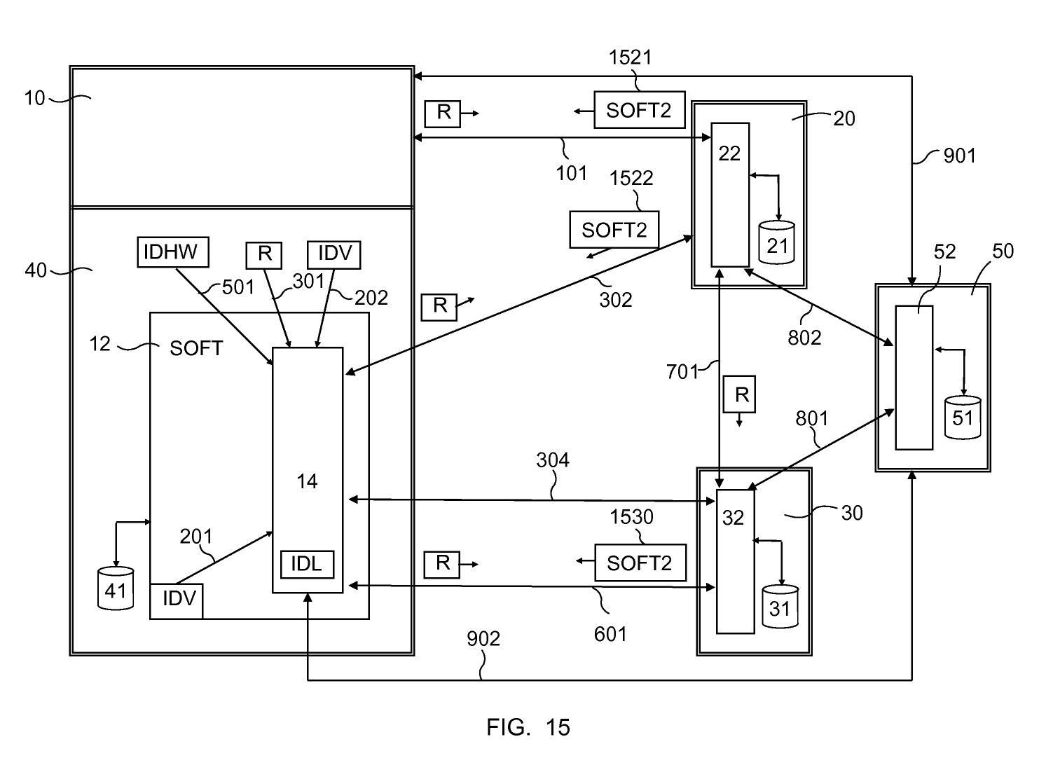

FIG. 15 illustrates other embodiments in which, after installing and running a SOFT program in device 40, by using for example any of the different embodiments explained previously, there is a second transmission to device 40 of SOFT2 data containing instructions which are executable on device 40. The SOFT2 data can be, for example, a file installable and/or runnable on device 40 or data containing instructions which are executable on device 40. The SOFT2 data may contain a computer program with instructions that are executable on device 40. Henceforth SOFT2 data will be referred to as SOFT2 program. In one implementation the SOFT2 program is an updated version of the SOFT program

Software companies usually release updated versions of their programs for several reasons. The SOFT2 program may correct a malfunction of the SOFT program and/or may solve security problems which enable the use of SOFT program vulnerabilities to illegally access device 40. The SOFT2 program may also be an updated version of the SOFT program, for instance, to incorporate new features or to detect and prevent the running of illegal copies of the SOFT program on device 40.

The SOFT2 program may be transmitted to device 40 in a number of ways. In a first mode of transmission, SOFT2 program 1521 is transmitted from the vendor site 20 to device 40 through communication 101. In a second form of transmission, the vendor site transmits SOFT2 program 1522 to device 40 through communication 302. In a third form of transmission, the licensing site transmits SOFT2 program 1530 to device 40 through communication 601. In the latter two examples communications 302 and 601 may be initiated by executable instructions of the SOFT program itself and/or by use of executable instructions in a COMP component associated with the SOFT program. For example, the COMP component may communicate on a regular basis with the vendor site 20 or licensing site 30 to check for new versions of the SOFT program to download.

In one implementation the SOFT2 program includes a new or updated COMP component replacing or otherwise updating the COMP component of the SOFT program. The updated COMP component may be, for example, a set of instructions that are executable on the device 40, organized for instance as functions or as classes.

In addition, as an option, device 40 may transmit the receipt data R in the communication via which it receives the SOFT2 program, for example, so that the vendor site 20 or licensing site 30 transmit the SOFT2 program only to those devices being in possession of receipt data associated with the purchase of the SOFT program.

In one embodiment, the SOFT2 program can also include a new functionality that is not included in the SOFT program that may require an additional payment or compensation (not shown in FIG. 15).

In one implementation the receipt data R associated with the SOFT program may include information about a subscription to receive all new versions of the SOFT program for a designated period of time (e.g., one month, one year, etc.). For this reason a SOFT2 program that includes new features is transmitted to device 40 without an additional payment. In this case, the vendor site 20 and/or licensing site 30 can verify that the receipt data R is associated with a subscription service and that the subscription service has not expired. In one implementation, the receipt data R includes information with a code identifying the subscription service and a date indicating when the subscription service ends.

To verify that the receipt data R is correct, the receipt may include an electronic signature of the vendor site 20, of the licensing site 30 or of the supervising site 50. Optionally, the vendor site 20 may communicate with the licensing site 30 to perform a verification relating to the receipt data R, and likewise both sites may communicate with the supervising site 50 to perform a verification.

Although FIG. 15 shows the transmission of the SOFT2 program from the vendor site 20 and from the licensing site 30, other combinations are possible. That is, the transmission of the SOFT2 program can be performed from other sites not shown in FIG. 15. For example, if the SOFT2 program is an updated version of the SOFT program that also works as a demo version on devices that are not licensed for use, the SOFT2 program can be transmitted to device 40 from any location since the demo versions of computer programs can usually be distributed from many sites.

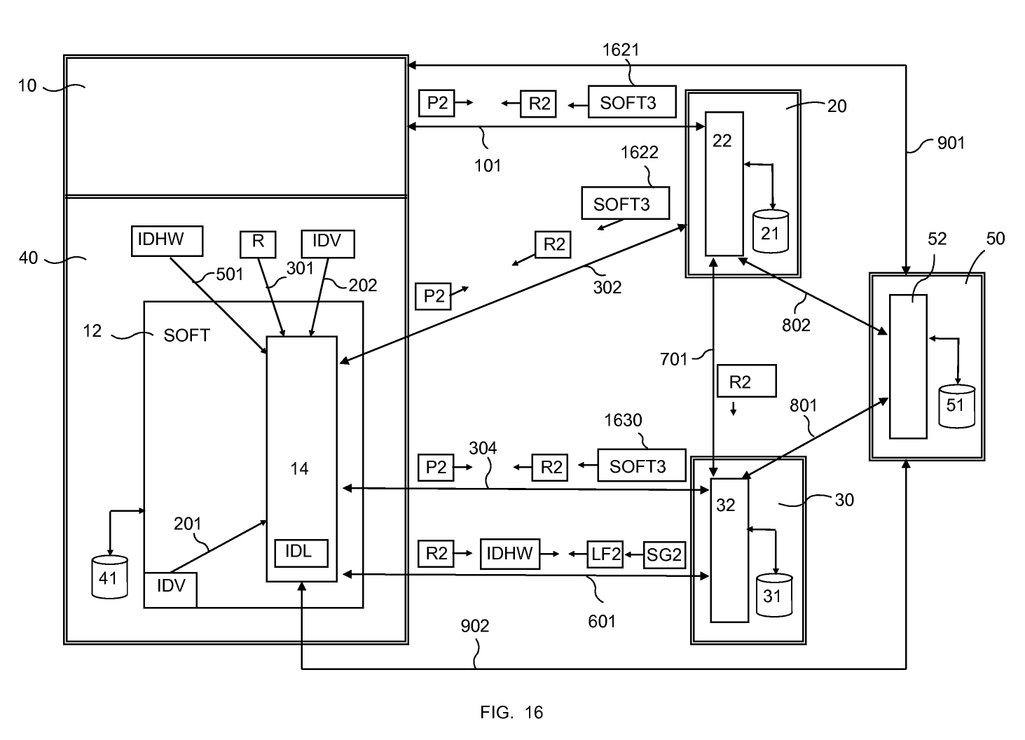

FIG. 16 illustrates other embodiments in which device 40 receives a new SOFT3 program, but unlike the examples in FIG. 15, in FIG. 16 there is a payment P2 associated with the acquisition of the SOFT3 program.

In one implementation, the SOFT3 program is an updated version of the SOFT program. The SOFT3 program can correct SOFT program malfunctions and/or may solve security problems which enable the use of SOFT program vulnerabilities to illegally access device 40. The SOFT3 program may also be an updated version of the SOFT program, for example, to incorporate new features or to prevent the running of illegal copies of the SOFT program on device 40

In one implementation, the SOFT3 program includes a new or updated COMP component that replaces or updates the COMP component of the SOFT program. The new or updated COMP component can be, for example, a set of instructions that are executable on the device 40, for example organized as functions or as classes.

FIG. 16 shows alternative ways in which the program SOFT3 can be transmitted to device 40 using different communications in which P2 data associated with an online payment and receipt data R2 associated with the SOFT3 program purchase are also transmitted.

The receipt data R2 can include, without limitation and in any combination, data identifying device 40, data regarding the user of device 40 who is making the online transaction, SOFT3 program identification data, data identifying licensing site 30, data identifying supervising site 50, data identifying the type of license associated with the purchase of the SOFT3 program such as a purchase license or a subscription license entitling the receipt of free new versions of the SOFT or SOFT3 program over a specified period.

The receipt data R2 can be transmitted to device 40 in a number of ways, such as, for example as a separate file from the SOFT3 file or as part of the SOFT3 file, or as metadata of the SOFT3 file. Other forms of transmission of receipt data R2 to device 40 are also possible, for example by using the http protocol or any other protocol for transmitting data in a data network.

FIG. 16 shows three examples or ways of transmitting the SOFT3 program and receipt data R2 to device 40 through communications 101, 302 and 304. The three communications also show the transmission from device 40 of P2 data associated with an online payment to receive the SOFT3 file. For example, P2 data can be data of a credit card placed on a web page 22 of the vendor site 20 or a web page 32 of the licensing site 30.

In a first example of transmission device 40 uses communication 101 with the vendor site 20 to transmit P2 data and to receive the SOFT3 program and receipt data R2. In a second example of transmission, a COMP component that runs on device 40 is used to establish communication 302 with the vendor site 20 to transmit P2 data and to receive the SOFT3 program and receipt data R2. In a third example of transmission device 40 uses communication 304 with the licensing site 30 to transmit P2 data and to receive the SOFT3 program and receipt data R2. This third example differs from a traditional online software purchase (e.g., one conducted on the same vendor and licensing site) in that prior to purchasing online the SOFT3 program at the licensing site 30, a first online purchase of the SOFT program at the vendor site 20 and an activation a SOFT program license by use of the licensing site 30 has already taken place. Only after this first transaction will the licensing site 30 conduct online transactions, such as direct online sales with device 40 of SOFT3 updates of the SOFT program. Device 40 can establish the communication 601, for example, by use of a COMP component associated with or otherwise embedded in the SOFT program or from the COMP component associated with or otherwise embedded in the SOFT3 program.

This enables, for example, a software company to advertise its programs by offering them on a vendor site 20 to attract new clients and then directly selling updates or other software to those clients without using or paying fees to the vendor site, for example, by selling updates of its programs directly from its own licensing web site 30 or from other web sites.

In other embodiments, the SOFT program can run a browser program (not shown in FIG. 16) in device 40 displaying a web page of the licensing site that enables the online purchase of the SOFT3 program from the browser itself directly from the licensing site's website. This means that the SOFT program can enable the direct purchase of the SOFT3 program from the device 40 at another site other than the vendor site, such as, for example, on web page 32 of the licensing site.

In other embodiments, the vendor site 20 can ban the sale of SOFT and SOFT3 programs if it detects that they allow certain online transactions at sites other than the vendor site 20, such as online transactions involving competition for the vendor site, such as the online sale through communication 304 in the third example of transmission of FIG. 16 described above. The vendor site 20 can detect that the COMP component included with the SOFT program sold on the vendor site 20, can perform online transactions on sites other than the vendor site 20, such as buying the SOFT3 program at the licensing site 30 through communication 304. The vendor site can perform such detection in a number of ways. One way is for the vendor site 20 to analyze the SOFT program's source code to see if it contains instructions, that when executed on device 40, enable the SOFT program to purchase from other web sites other than the vendor site 20. Another way is for the vendor site 20 to test the operation of the SOFT program without analyzing its source code, for example by installing this SOFT program on one device and studying its operation to check whether, for example, the SOFT program tries to buy the SOFT3 program from a site other than the vendor site 20. Another way is for the vendor site 20 to detect that the SOFT program makes a transaction for the purchase of SOFT program related software, such as the SOFT3 program through an application or instructions that run on the operating system of device 40. For example, the operating system 40 can execute instructions to store the program information acquired, installed or running on device 40 and transmit that information to the vendor site thus detecting that device 40 has acquired the SOFT3 program at the licensing site or some other site.

FIG. 16 illustrates alternative ways in which the SOFT3 program can run on device 40. These may include, without limitation, in two different ways using the same SOFT program LF license or using a new license to be obtained from the licensing site 30. In the latter case, once device 40 receives the SOFT3 program and the receipt data R2, it establishes a communication 601 with the licensing site 30 via which it transmits the receipt data R2 and IDHW data, such as data that identifies a piece of hardware on device 40, to activate the SOFT3 program license by receiving LF2 and SG2 data, which may be, for example, a license file LF2 and an electronic signature SG2. Device 40 can store such LF2 and SG2 data, for example, in database 41.

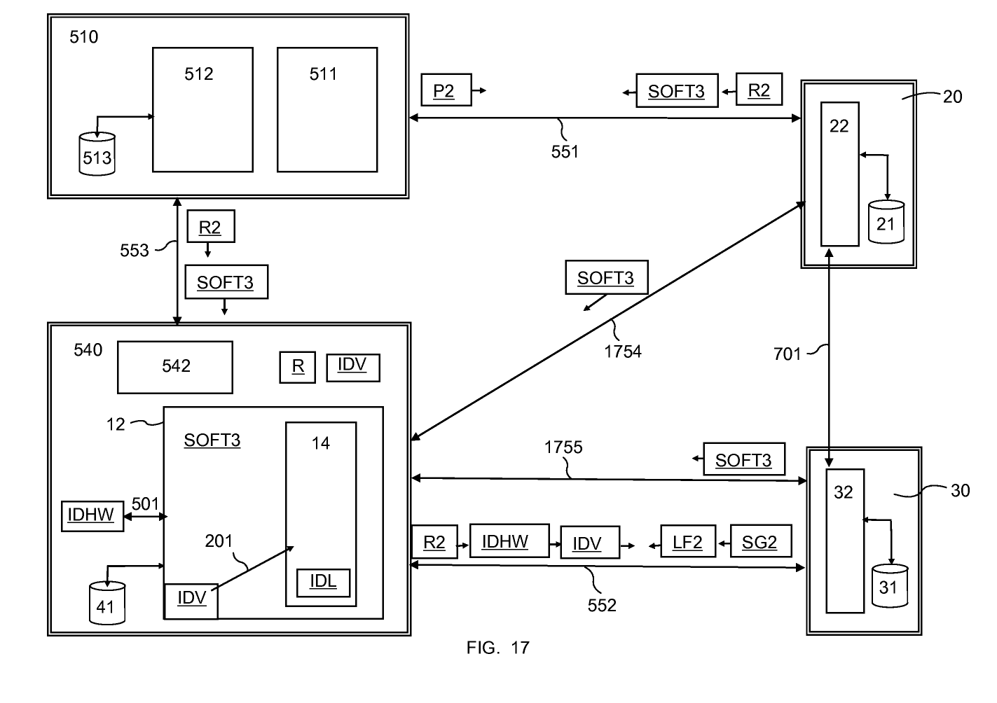

FIG. 17 illustrates other embodiments involving two programmable electronic devices 510 and 540. In one implementation the purchase transaction of the SOFT3 program is performed from device 510 through communication 551 with vendor site 20 and the transaction for the activation of the SOFT3 program license is performed from device 540 through communication 552. The download of the SOFT3 program to device 540 can be performed in different ways. One way is through communications 551 and 553; a second form is through communication 1754; and a third form is through communication 1755.

It is important to note that although some embodiments are explained using figures showing a single programmable electronic device and other embodiments are explained with figures showing multiple programmable electronic devices, various embodiments of the present invention may be executed interchangeably with one programmable electronic device or multiple programmable electronic devices. For example, with respect to the embodiments of FIG. 17 any of a variety of implementations, or combinations thereof, described in conjunction with FIG. 16 or any of the others may be implemented. However, for the sake of simplicity not every combination of implementations are explicitly illustrated or described. Also, it is to be appreciated that certain implementations have not been repeatedly described in conjunction with each of the figures. For example, an online purchase in an implementation of FIG. 17 may occur from browser 511 and/or from application 512 in ways similar to that previously described.

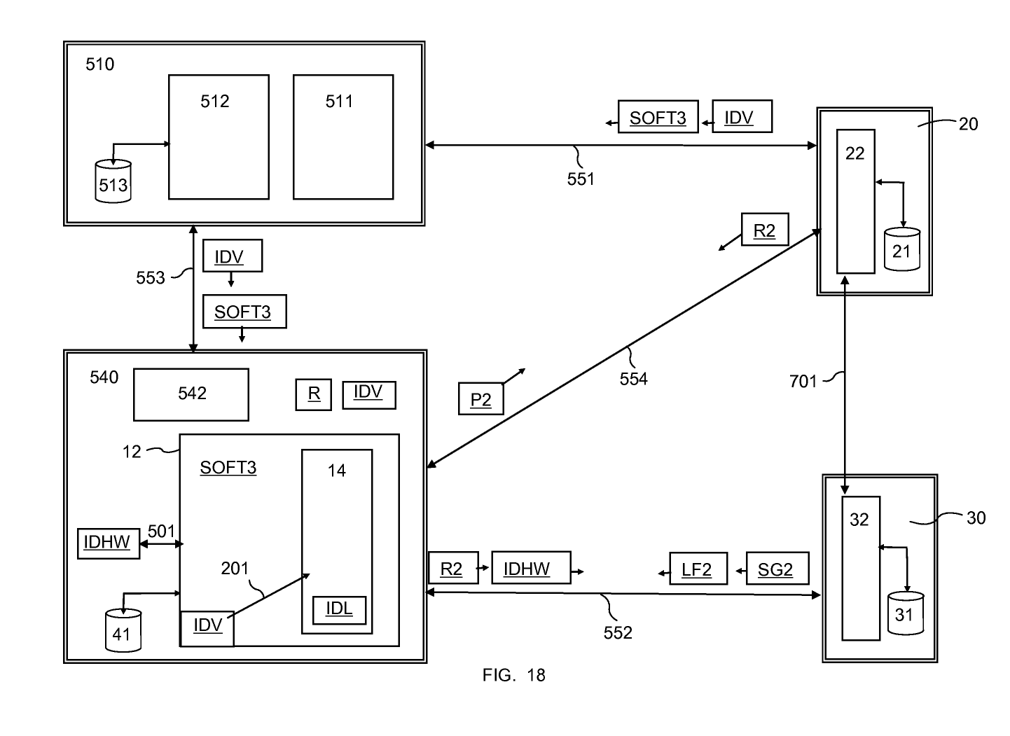

FIG. 18 shows other embodiments in which an online purchase of the SOFT3 program is done from device 540 and the activation of the SOFT3 program license is also performed from device 540. The download of the SOFT3 program is performed through device 510 using communications 551 and 553.

A download of the SOFT3 program can be performed before the purchase transaction of the SOFT3 program (before communication 554), after the purchase transaction of the SOFT3 program and before activating the SOFT3 program license (after communication 554 and before communication 552) or after activating the SOFT3 program license (after communication 552).

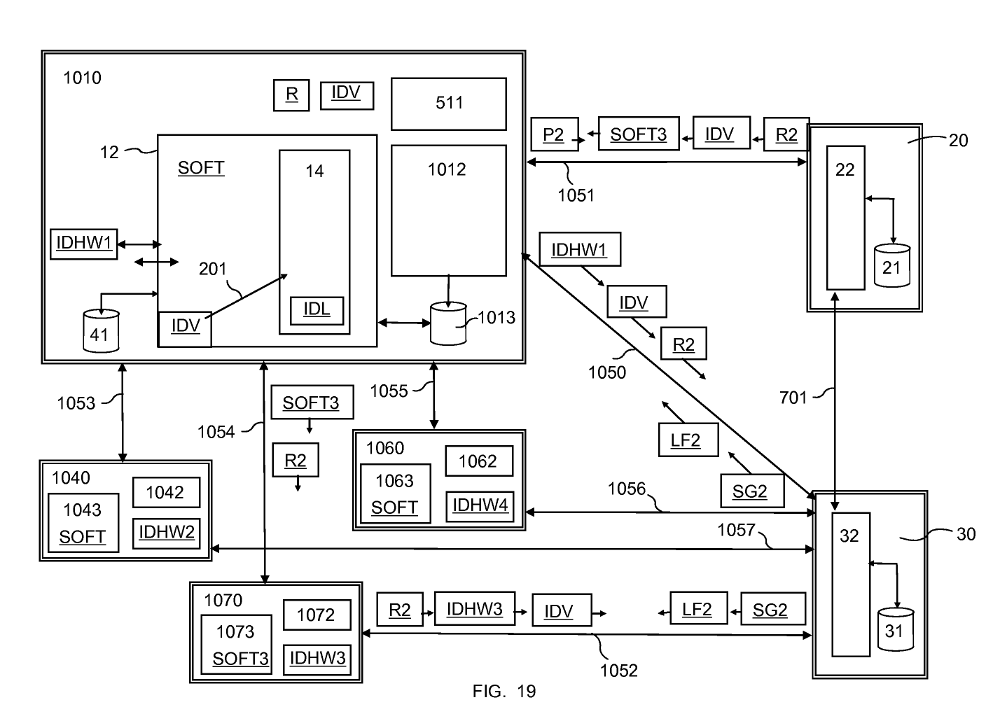

FIG. 19 illustrates other embodiments in which device 1010 makes an online purchase of the SOFT3 program through communication 1051 with the vendor site 20, and activates the license of the SOFT3 program through communication 1050 with the licensing site 30. Device 1010 can install and run the SOFT3 program and also transmit it to other devices 1040, 1060 and 1070.

Although FIG. 19 shows the SOFT3 program only being downloaded from the vendor site 20 through communication 1051, other combinations are possible. For example, the SOFT3 program may be downloaded from other sites, such as from the licensing site 30 using communication 1050.

Similarly to what has been previously explained in FIG. 10 in conjunction with the SOFT program, the SOFT3 program license purchased by device 1010 on the vendor site 20 may allow the use of the SOFT3 program in a given number of devices. For instance, device 1010 can choose the number of devices in which it wants to run the SOFT3 program when carrying out the online purchase at the vendor site. Information on the number of devices that can use the SOFT3 program can be included, for example, in the receipt data R2. Such receipt data R2 may also include an electronic signature of the vendor site to prevent the receipt data R2 from being modified to alter the number of devices allowed to run the SOFT3 program.

In one embodiment, the number of devices authorized to use the SOFT3 program is the same number of devices authorized to use the SOFT program indicated in the receipt data R associated with the purchase of the SOFT program.

The devices 1040, 1060 and 1070 may have an application 1042, 1062 and 1072, respectively, allowing them to communicate with device 1010, for example with the application 1012 of device 1010, in order to receive the SOFT3 program together with the receipt data R2. For the purpose of simplifying FIG. 19, the transmission of data is only shown in communication 1054, although the SOFT3 program is shown installed in the devices 1040, 1070 and 1060.

In other implementations, applications 1042, 1062 and 1072 may also enable devices 1040, 1060 and 1070 to purchase the SOFT3 program online at the vendor site 20, to receive the SOFT3 program from the vendor site 20 and to transmit the SOFT3 program together with the receipt data R2 to other devices. In this manner the purchase of the SOFT3 program can be made from any of the devices 1010, 1040, 1060 and 1070.

In the embodiments of FIG. 19, each device running the SOFT3 program can perform a license activation through a communication with the licensing site 30. However, other combinations are possible, such as the one shown in FIG. 11 where the activation of licenses is performed from device 1010 in a centralized manner.

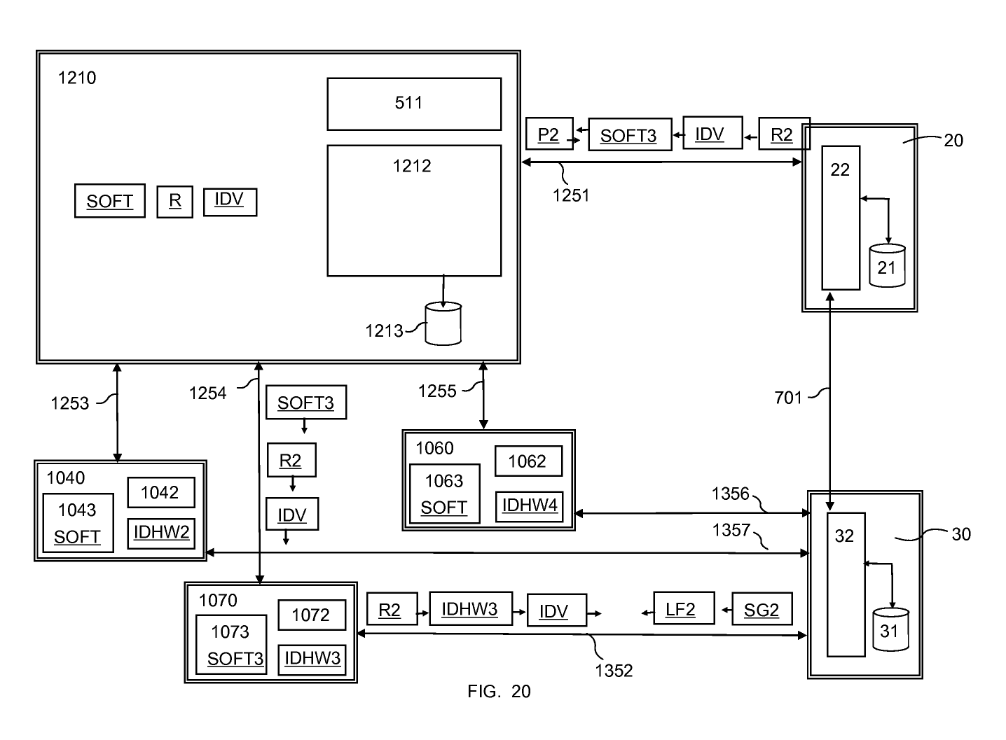

FIG. 20 illustrates other embodiments similar to those described in conjunction with FIGS. 12 and 13. For example, the SOFT3 program is acquired from a device 1210 that does not run the SOFT3 program. Instead, the SOFT3 program is installed and run on the devices 1040, 1060 and 1070, while device 1210 acquires and stores a copy of the file containing the SOFT3 program together with the receipt data R2, without installing or running the SOFT3 program.

In one embodiment, device 1210 uses, for example, an operating system that does not allow the running of the SOFT3 program.

Device 1210 communicates with the devices 1040, 1070 and 1060 using communications 1253, 1254 and 1255, respectively, and transmits the file containing the SOFT3 program to such devices so they can install and/or run the SOFT3 program.

In the embodiments of FIG. 20, each device that runs the SOFT3 program can perform license activation through a communication with the licensing site 30. However, other combinations are possible, such as that shown in FIG. 12 where the activation of licenses is carried out from device 1210 in a centralized manner.

Although FIG. 20 shows the SOFT3 program being downloaded from the vendor site 20 through communication 1251, the SOFT3 program may be downloaded from other sites, such as, for example, from the licensing site 30.

Equally applicable to the examples of FIGS. 17 to 20 are the embodiments described in FIG. 16, in which a purchase transaction is made through communication 304 in the licensing site 30 instead of the vendor site 20.

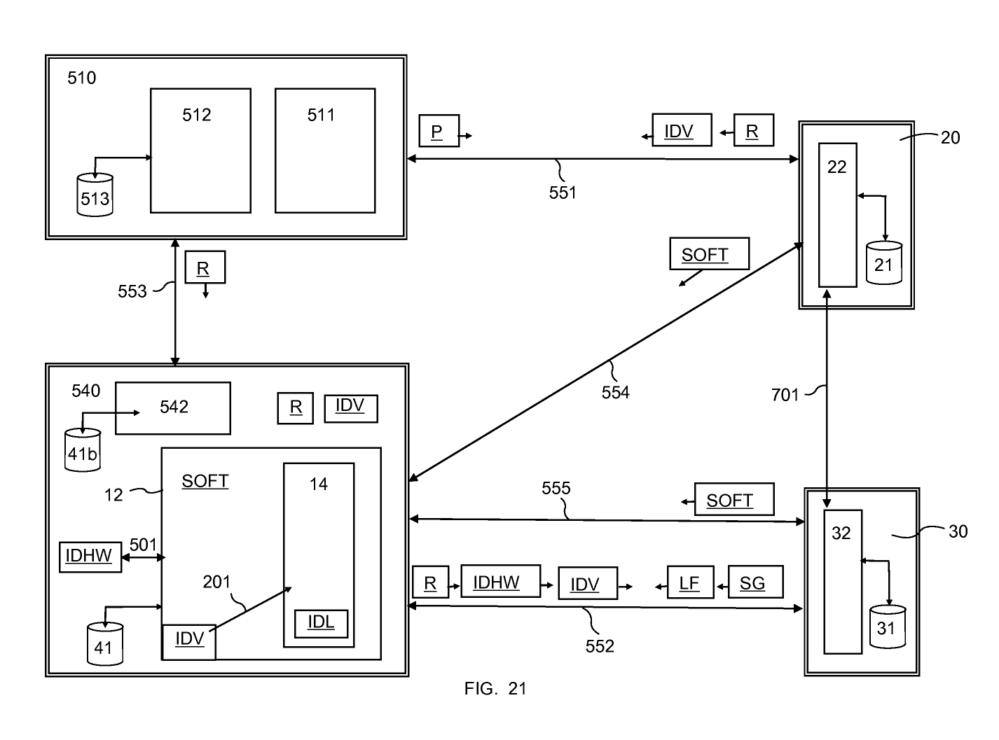

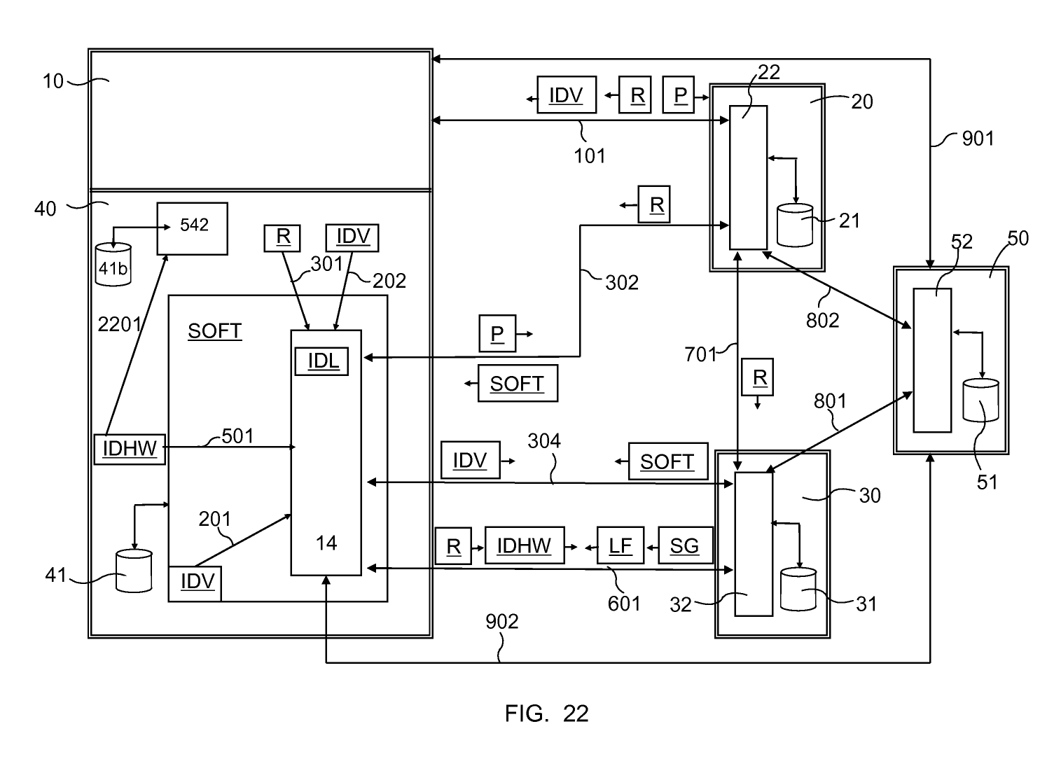

Reverting to the original problem of purchasing the SOFT program, FIGS. 21 and 22 show other embodiments in which the SOFT program download is performed after the online purchase at a vendor site and after activating a license, or other use enabling modality, from a licensing site.

FIG. 21 shows an example with two programmable electronic devices 510 and 540, while FIG. 22 shows an example with a single programmable electronic device 40.

With reference to FIG. 21, device 510 transmits payment data P through communication 551 to the vendor site 20 and receives in return receipt data R and IDV identification data. Device 510 then transmits the receipt data R and IDV data to device 540 through communication 553.

In one implementation an application 542 on device 540 receives the receipt data R and the IDV data and stores the data in a database 41b. After receiving the R and IDV data, application 542 is used to initiate a process for activating a license, or other use enabling modality, to enable the use of the SOFT program on device 540. In one implementation the activation process involves establishing communication 552 with the licensing site 30 and transmitting the R data, IDHW identification data of device 540 and IDV data and in return receiving data that allows the use of the SOFT program on device 540. In one implementation the process involves transmitting from the licensing site license data LF and an electronic signature SG to activate a use license. In such an implementation, application 542 may store the LF and SG data in database 41b.

Once a use of the SOFT program on device 540 has been granted, device 540 has the ability to download, install and run the SOFT program. For example, the download can be performed from the vendor site 20 through communication 554 or from the licensing site 30 through communication 555.

In one implementation, when the SOFT program is running on the device 540, a COMP component associated with the SOFT program accesses the database 41b and checks that there is a license, or other use enabling data, that authorizes the use of the SOFT program on device 540.

The processes in the example of FIG. 22 are similar to that of FIG. 21, with the difference that there is a single programmable device 40. In one implementation device 40 transmits through communications 101 or 302 payment data P to the vendor site 20 and receives from the vendor site receipt data R and IDV identification data.

In one implementation an application 542 on device 540 receives the receipt data R and the IDV data and stores the data in a database 41b. After receiving the R and IDV data, application 542 is used to initiate a process for activating a license, or other use enabling modality, to enable the use of the SOFT program on device 40. In one implementation the activation process involves establishing communication 304 with the licensing site 30 and transmitting the R data, IDHW identification data of device 540 and IDV data and in return receiving data that allows the use of the SOFT program on device 40. In one implementation the process involves transmitting from the licensing site license data LF and an electronic signature SG to activate a use license. In such an implementation, application 542 may store the LF and SG data in database 41b.

Once a use of the SOFT program on device 40 has been granted, device 40 has the ability to download, install and run the SOFT program. For example, the download can be performed from the vendor site 20 through communication 302 or from the licensing site 30 through communication 304.

In one implementation, when the SOFT program is running on device 40, a COMP component associated with the SOFT program accesses the database 41b and checks that there is a license, or other use enabling data, that authorizes the use of the SOFT program on device 40.

In various implementations databases 41 and 41b are the same database. This enables different programs to use the same database to store their purchase and activation information, such as R, IDV, IDL, IDHW, LF and SG data.

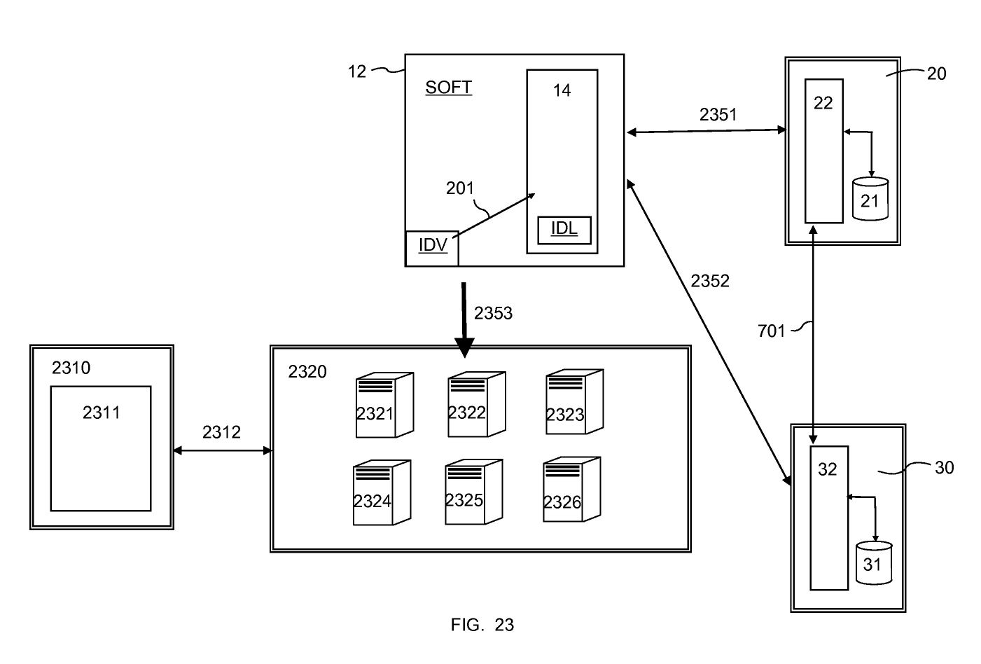

FIG. 23 shows other embodiments of the present invention. As explained above the present invention can be implemented in any programmable devices including, without limitation, client-type and/or server-type computers in client-server architectures or in networked computers in distributed network architectures. FIG. 23 illustrates an embodiment implemented in a client-server architecture.

Although FIG. 23 shows a single client computer 2310, it is to be appreciated that the embodiments may be implemented in a system comprising multiple client computers. In one implementation the client computer 2310 runs an application 2311 that may be, for example, an Internet browser.

FIG. 23 also shows a group of servers 2320 which comprises six servers, namely 2321 to 2326. The servers 2320 enable the execution of computer programs and may comprise fewer than or more than six servers.

In one implementation, the SOFT program can be run partially on the client computer 2310 and partly on one or more of the servers 2320. For example, client 2310 can display the user interface of the SOFT program and the servers 2320 can perform other functions and processes, such as database access.

The arrow 2353 shown in FIG. 23 indicates that the SOFT program is running wholly or partly in one or more of the servers 2320. For example, the SOFT program can run on server 2322 and the user can access the SOFT application through the browser 2311 using communication 2312. In one implementation a COMP component that may run within the SOFT program enables, for example, the online purchase of the program through communication 2351 with the vendor site 20, while activating the SOFT program license through communication 2352 with the licensing site 30.

COMP component instructions can be executed on the client computer 2310 or on the servers 2320. Likewise, a first portion of COMP component instructions can be executed in the computer 2310 with a second portion of COMP component instructions executed on one or more of servers 2320.

In one embodiment, a COMP component can run partially on the client device 2310 and partially on one or more of servers 2320. For example, a first set of instructions running of the client device 2310 may produce a user interface to facilitate an online purchasing process while a second set of instructions running on server 2322 facilitates an activation of a license from the server 2322.

In another example, the COMP component can make an online purchase of the SOFT program license through instructions that run on computer 2310 and activate the SOFT program license through instructions that run on or more of the servers 2320.

Although FIG. 23 has been used to show alternative implementations in a distributed network architecture, other implementations are possible within a variety of other types of distributed network architectures.

Many features and advantages of the embodiments are apparent from the detailed specification. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof

What is claimed is:

1. A method comprising:
purchasing by use of a first programmable electronic device a software product from a first site and receiving in the first programmable electronic device the software product and purchase receipt data from the first site, the software product comprising a software program;
transmitting from the first programmable electronic device at least a portion of the software product and the purchase receipt data to a second programmable electronic device;
initiating, by use of first executable instructions associated with the software product, communication between the second programmable electronic device and a second site different from the first site and transferring from the second programmable electronic device at least a portion of the purchase receipt data to the second site; and
receiving in the second programmable electronic device from the second site use enabling data associated with the software product that enables the software program to be run on the second programmable electronic device.

2. A method according to claim 1, wherein the purchase receipt data comprises identification data of the first site.

3. A method according to claim 1, further comprising transmitting from the first site to the first programmable electronic device identification data of the first site, transmitting the identification data of the first site from the first programmable electronic device to the second programmable electronic device, and transmitting the identification data of the first site from the second programmable electronic device to the second site.

4. A method according to claim 1, further comprising transmitting from the second programmable electronic device to the second site hardware identification data of the second programmable electronic device.

5. A method according to claim 1, wherein the first executable instructions associated with the software product are included within the software product.

6. A method according to claim 1, wherein the first executable instructions associated with the software product are a part of the software program.

7. A method according to claim 6, wherein the first executable instructions are a component embedded in the software program.

8. A method according to claim 1, wherein the software product comprises an inactive software program use license, the second site transmitting to the second programmable electronic device the use enabling data in the form of use license activation data that activates the inactive use license in the second programmable electronic device.

9. A method according to claim 1, wherein the software product comprises second executable instructions that when executed establish communication between the second programmable electronic device and either the first site, second site or a third site to determine if a new version or new feature of the software program exists.

10. A method according to claim 1, wherein upon determining that a new version or new feature exists, third executable instructions within the software product produce a user interface on the second programmable electronic device that permits a user to initiate a purchase of the new version or new feature from site where the new version or new feature exists.

11. A method comprising:
purchasing by use of a first programmable electronic device a software product from a first site and receiving in the first programmable electronic device from the first site purchase receipt data and identification data of the first site, the software product comprising a software program;
transmitting from the first programmable electronic device at least a portion of the purchase receipt data and the identification data to a second programmable electronic device;
establishing by use of the identification data a communication between the first site and the second programmable electronic device and transmitting from the first site to the second programmable electronic device the software product;
initiating communication between the second programmable electronic device and a second site different from the first site and transferring from the second programmable electronic device at least a portion of the purchase receipt data to the second site; and
receiving in the second programmable electronic device from the second site use enabling data associated with the software product that enables the software program to be run on the second programmable electronic device.

12. A method according to claim 11, wherein communication between the second programmable electronic device and the second site is accomplished at least in part by use of executable instructions associated with the software product.

13. A method according to claim 11, further comprising transmitting the identification data of the first site from the second programmable electronic device to the second site.

14. A method according to claim 11, further comprising transmitting from the second programmable electronic device to the second site hardware identification data of the second programmable electronic device.

15. A method according to claim 12, wherein the executable instructions associated with the software product are included within the software product.

16. A method according to claim 12, wherein the executable instructions associated with the software product are a part of the software program.

17. A method according to claim 16, wherein the executable instructions are a component embedded in the software program.

18. A method according to claim 11, wherein the software product comprises an inactive software program use license, the second site transmitting to the second programmable electronic device the use enabling data in the form of use license activation data that activates the inactive use license in the second programmable electronic device.

19. A method according to claim 11, wherein receiving in the second programmable electronic device from the second site use enabling data associated with the software product that enables the software program to be run on the second programmable electronic device occurs prior to transmitting from the first site to the second programmable electronic device the software product.

20. A method comprising:
purchasing by use of a first programmable electronic device a software product from a first site and receiving in the first programmable electronic device from the first site purchase receipt data and identification data of the first site, the software product comprising a software program;
transmitting from the first programmable electronic device at least a portion of the purchase receipt data and the identification data to a second programmable electronic device;
establishing by use of the receipt data and/or identification data a communication between the second programmable electronic device and a second site different from the first site;
transmitting from the second site to the second programmable electronic device the software product;
initiating, by use of executable instructions associated with the software product, communication between the second programmable electronic device and a third site and transferring from the second programmable electronic device at least a portion of the purchase receipt data to the third site; and
receiving in the second programmable electronic device from the third site use enabling data associated with the software product that enables the software program to be run on the second programmable electronic device.

21. A method according to claim 20, wherein the second site and the third site are the same site.

22. A method according to claim 20, further comprising transmitting the identification data of the first site from the second programmable electronic device to the third site.

23. A method according to claim 20, further comprising transmitting from the second programmable electronic device to the third site hardware identification data of the second programmable electronic device.

24. A method according to claim 20, wherein the executable instructions associated with the software product are included within the software product.

25. A method according to claim 20, wherein the executable instructions associated with the software product are a part of the software program.

26. A method according to claim 25, wherein the executable instructions are a component embedded in the software program.

27. A method according to claim 20, wherein the software product comprises an inactive software program use license, the third site transmitting to the second programmable electronic device the use enabling data in the form of use license activation data that activates the inactive use license in the second programmable electronic device.

28. A method comprising:
receiving in a first programmable electronic device a demonstration software product from a first site and identification data of the first site, the software product comprising a software program having one or more use restrictions;
transmitting from the first programmable electronic device to a second programmable electronic device the demonstration software product and the identification data of the first site;
establishing by use of the identification data of the first site and/or information within the software product a communication between the second programmable electronic device and the first site;
purchasing from the first site by use of the second programmable electronic device a software program use license or other use modality and receiving in the second programmable electronic device from the first site purchase receipt data;
initiating, by use of the receipt data and/or executable instructions associated with the demonstration software product, a communication between the second programmable electronic device and a second site different from the first site, and transferring from the second programmable electronic device at least a portion of the purchase receipt data to the second site; and
receiving in the second programmable electronic device from the second site use enabling data or license activation data that enables the software program to be run on the second programmable electronic device without one or more of the restrictions.

29. A method according to claim 28, further comprising transmitting the identification data of the first site from the second programmable electronic device to the second site.

30. A method according to claim 28, further comprising transmitting from the second programmable electronic device to the second site hardware identification data of the second programmable electronic device.

31. A method according to claim 28, wherein the executable instructions associated with the demonstration software product are included within the demonstration software product.

32. A method according to claim 28, wherein the executable instructions associated with the demonstration software product are a part of the software program.

33. A method according to claim 32, wherein the executable instructions are a component embedded in the software program.
